(19) United States
(12) Patent Application Publication
(10) Pub. No.: US 2016/0009996 A1
(43) Pub. Date: Jan. 14, 2016

(54) LIQUID CRYSTAL COMPOSITION AND LIQUID CRYSTAL DISPLAY DEVICE

(71) Applicant: JIANGSU HECHENG DISPLAY TECHNOLOGY CO., LTD., Yangzhong, Jiangsu (CN)

(72) Inventors: Wenming HAN, Yangzhong, Jiangsu (CN); Feng WU, Yangzhong, Jiangsu (CN); Dingfu MA, Yangzhong, Jiangsu (CN); Dongdong ZHAO, Yangzhong, Jiangsu (CN); Jiahao YAN, Yangzhong, Jiangsu (CN)

(21) Appl. No.: 14/770,754

(22) PCT Filed: Mar. 12, 2014
(86) PCT No.: PCT/CN2014/073266

§ 371 Date: Aug. 26, 2015

(30) Foreign Application Priority Data
Mar. 13, 2013 (CN) 201310079890.5

(51) Int. Cl. C09K 19/30

(52) U.S. Cl. CPC C09K 19/3066

(57) ABSTRACT

The present invention provides a liquid crystal composition, the liquid crystal composition including at least one compound of general formula (I); at least one compound of general formula (II) that accounts for 5-75% of the total weight of the liquid crystal composition; at least one compound of general formula (III) that accounts for 0-25% of the total weight of the liquid crystal composition; and at least one compound of general formula (IV) that accounts for 5-75% of the total weight of the liquid crystal composition. The liquid crystal composition of the present invention has characteristics of great optical anisotropy, small viscosity, good low-temperature stability, high stability against ultraviolet rays and high thermal stability, is applicable to AM elements, and has characteristics such as a short corresponding time, great contrast and a long service life. The present invention further provides an active matrix liquid crystal display device including the liquid crystal composition.

### FIELD OF THE INVENTION

The present invention relates to a liquid crystal composition, and in particular, to a liquid crystal composition that has great optical anisotropy, small viscosity, good low-temperature stability, high stability against ultraviolet rays and high thermal stability. The present invention further relates to a liquid crystal display device including the liquid crystal composition.

### DESCRIPTION OF RELATED ART

A liquid crystal material is a liquid crystal phase material between a solid phase and a liquid phase and is mainly used as a dielectric in displays, for which the reason is that optical performance of such materials may be changed by an applied voltage. Electro-optic devices based on liquid crystal are well-known by persons skilled in the art and may include various effects. Examples of such devices are liquid crystal cells having dynamic scattering, deformation of aligned phase (DAP) liquid crystal cells, guest/host liquid crystal cells, TN cells having a twisted nematic structure, super twisted nematic (STN) liquid crystal cells, supertwisted birefringent effect (SBE) liquid crystal cells and optical membrane interference (OMI) liquid crystal cells. The most common displays are based on the Schadt-Helfrich effect and have a twisted nematic structure. In addition, there are also liquid crystal cells used to be operated in parallel to electric fields of substrates and liquid crystal planes, for example, in-plane switching (IPS) liquid crystal cells. In particular, TN, STN and IPS liquid crystal cells, especially TN and IPS liquid crystal cells are current application fields having commercial significance for the medium of the present invention.

The liquid crystal material must have good chemical and thermal stability and good stability against an electric field and electromagnetic radiation. In addition, the liquid crystal material should have low viscosity and generate a short addressing time, a low threshold voltage and high contrast in the liquid crystal cells. For a liquid crystal display, liquid crystal compounds and liquid crystal mediums having thermal stability, good dielectric properties and lower viscosity meet current requirements.

Optical anisotropy of a composition is associated with the contrast of an element. In order to maximize a contrast ratio of a liquid crystal display element, design can be made by setting a product value (Δn*d) of the optical anisotropy (Δn) of a liquid crystal composition and the thickness (d) of a liquid crystal layer to a fixed value. An appropriate product value depends on the type of an operation mode. For example, an appropriate value of an element in a TN mode is about 0.45 μm. In this case, for an element of which the thickness of the liquid crystal layer is relatively small, a composition with great optical anisotropy is preferred. The great dielectric anisotropy of the composition helps the element to have a low critical voltage, small consumed power and great contrast. Therefore, great dielectric anisotropy is preferred. Great electrical resistivity of the composition helps the element to have a great voltage retention ratio and great contrast. Therefore, a composition having greater electrical resistivity at the room temperature as well as at high temperatures in an initial phase is preferred. A composition having greater electrical resistivity at the room temperature as well as at high temperatures after long-time use is preferred. The stability of the composition against ultraviolet rays and heat is relevant to the service life of the liquid crystal display element. When the stability is high, the service life of the element is long. Such a characteristic is preferred for AM elements used in liquid crystal projectors, liquid crystal TVs and the like.

A preferable AM element has characteristics such as a broad usable temperature range, a short response time, great contrast, a lower critical voltage, a large voltage retention ratio, and a long service life, and preferably, the response time is even shorter than 1 millisecond. Therefore, the characteristics of the composition are, preferably, a nematic phase with a high ceiling temperature, a nematic phase with a low floor temperature, low viscosity, great optical anisotropy, great dielectric constant anisotropy, great electrical resistivity, high stability against ultraviolet rays, high stability against heat, and the like.

It is usually difficult for a single liquid crystal compound to give play to its characteristics, and it is common to mix the liquid crystal compound with other various liquid crystal compounds to prepare a composition. Therefore, a liquid crystal composition having the foregoing advantages is urgently needed, and if the compound mentioned in Chinese Publication No. CN1823151A is prepared into a liquid crystal composition, preferable characteristics can be obtained, and the structure of the compound is as follows:

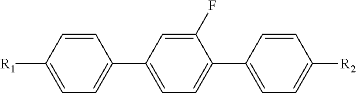

However, dielectric anisotropy of the compound mentioned in the patent application is still not great enough.

The invention structure in the European Publication No. EP2292720A1 is as follows:

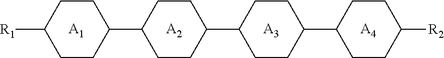

However, the compound mentioned in the document still cannot individually meet the requirements of the present invention.

An objective of the present invention is to provide a liquid crystal composition which has at least one characteristic in the characteristics of a nematic phase having a high ceiling temperature, a nematic phase having a low floor temperature, low viscosity, great optical anisotropy, great dielectric anisotropy, great electrical resistivity, high stability against ultraviolet rays, high stability against heat and the like. The liquid crystal composition is applicable to an AM element to make the AM element have characteristics of a short response time, a great voltage retention ratio, great contrast, a long service life and the like.

### SUMMARY OF THE INVENTION

In one aspect, the present invention provides a liquid crystal composition, including: at least one compound of general formula I that accounts for 1-30% of the total weight of the liquid crystal composition:

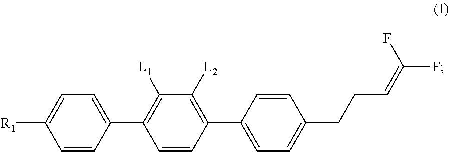

at least one polar compound of general formula II that accounts for 5-75% of the total weight of the liquid crystal composition:

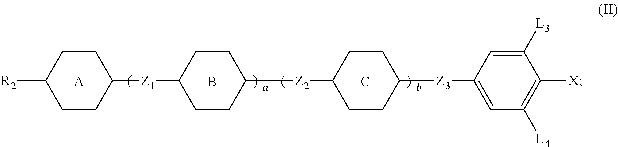

at least one compound of general formula III that accounts for 0-25% of the total weight of the liquid crystal composition:

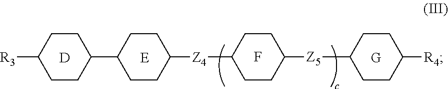

and
at least one compound of general formula IV that accounts for 5-75% of the total weight of the liquid crystal composition:

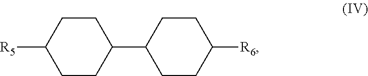

where:
R₁, R₂, R₃, R₄, R₅ and R₆ are the same or different, respectively independently selected from a group consisting of alkyl or alkoxy of which the number of carbon atoms is 1-15 and alkenyl or alkenoxy of which the number of carbon atoms is 2-15;
L₁, L₂, L₃ and L₄ are the same or different, respectively independently being H or F, and at least one of L₁ and L₂ is F;

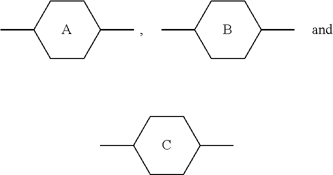

are the same or different, respectively independently selected from a group consisting of

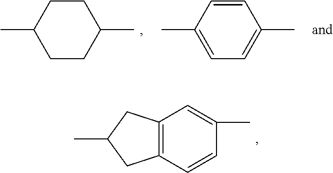

where one or more H in

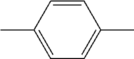

can be independently replaced by F;

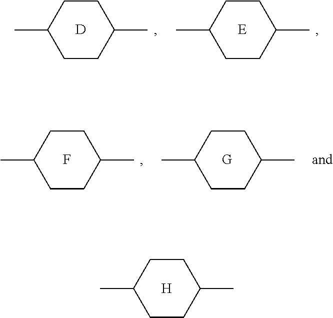

are the same or different, respectively independently selected from a group consisting of

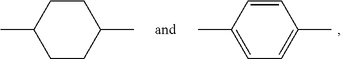

where one or more H in

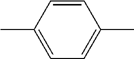

can be independently replaced by F;
X denotes F, Cl, CN, or fluoroalkyl or fluoroalkoxy of which the number of carbon atoms is 1 to 5;
Z₁, Z₂, Z₃, Z₄ and Z₅ are the same or different, respectively independently selected from a group consisting of a C—C single bond, —COO—, —OCO—, —CF₂O—, —CH₂O—, —CH₂CH₂—, —CF₂CH₂—, —CF═CF—, —CH═CH—, —CH═CF—, —C₂F₄—, —(CH₂)₄—, —(CF₂)₄—, —OCF₂CF₂O—, —CF₂CF₂CF₂O—, —CH₂CH₂CF₂O—, —OCH₂CF₂O—, —OCF₂CH₂O—, —CH₂CF₂OCH₂—, —CH═CHCF₂O—, —CF₂OCH═CH—, —CF₂OCF═CH—, —CF₂OCH═CF—, —CF═CFCF₂O—, —CF₂OCF═CF—, —C₂H₄OCH₂—, —CH═CHCH₂CH₂—, —CH₂CH═CHCH₂—, —OCH₂CH₂CH₂—, —CF═CF—CF═CF—, —CF≡C—, —C≡C—CF═CF—, —C≡C—CF═CF—C≡C—, —CF═CF—C≡C—CF═CF—, and —C≡C—CF₂O—; and
a, b and c are the same or different, respectively independently indicating 0, 1 or 2.

The liquid crystal composition of the present invention includes at least two compounds of the general formula I, which account for 2-30% of the total weight of the liquid crystal composition, or the liquid crystal composition only includes one compound of the general formula I, which accounts for 1-8% of the total weight of the liquid crystal composition.

In an implementation solution of the present invention, a compound of the general formula I is selected from one or more compounds in a group consisting of compounds of general formula I-1:

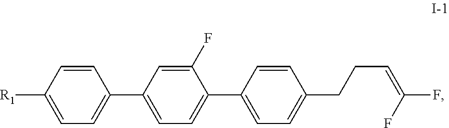

where:
the R₁ is selected from a group consisting of alkyl or alkoxy of which the number of carbon atoms is 1-7 and alkenyl or alkenoxy of which the number of carbon atoms is 2-7.

In an implementation solution of the present invention, a compound of the general formula II is selected from one or more compounds in a group consisting of the following compounds:

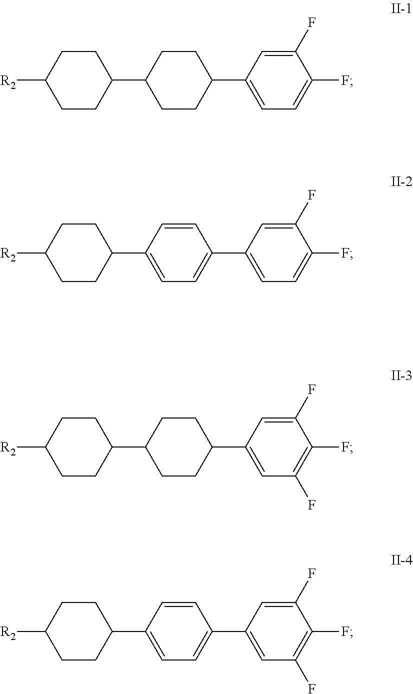

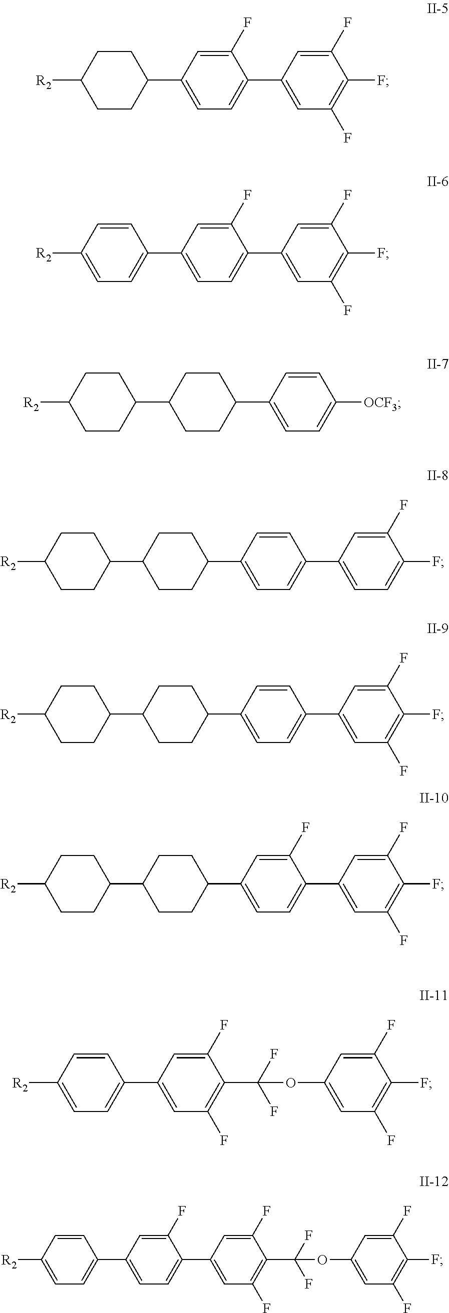

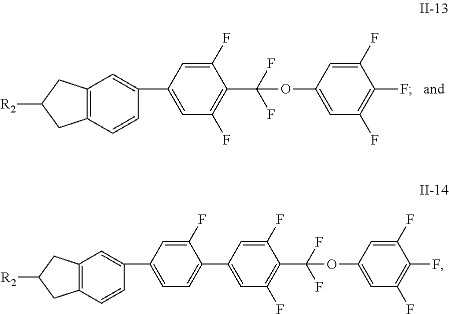

where:
the R₂ is selected from a group consisting of alkyl or alkoxy of which the number of carbon atoms is 1-7 and alkenyl or alkenoxy of which the number of carbon atoms is 1-7.

In an implementation solution of the present invention, a compound of the general formula III is selected from one or more compounds in a group consisting of the following compounds:

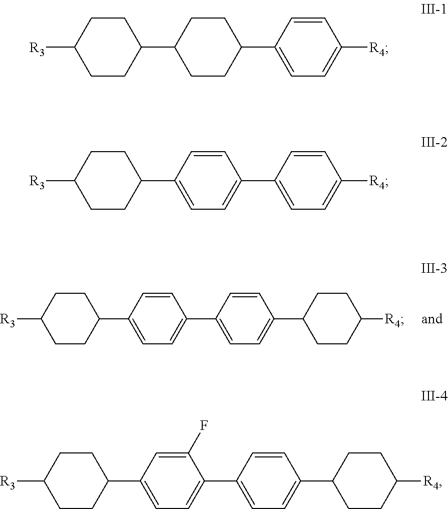

where:
the R₃ and the R₄ are the same or different, respectively independently indicating alkyl or alkoxy of which the number of carbon atoms is 1-7, or alkenyl of which the number of carbon atoms is 2-7.

In an implementation solution of the present invention, a compound of the general formula IV is selected from one or more compounds in a group consisting of the following compounds:

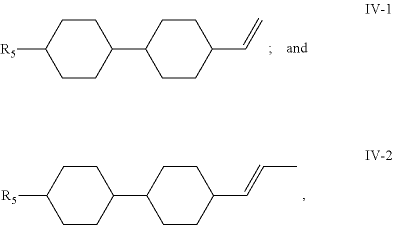

where:
the R₅ is selected from a group consisting of alkyl of which the number of carbon atoms is 1-7 and alkoxy of which the number of carbon atoms is 1-7.

In another aspect, the present invention provides a liquid crystal display device, the liquid crystal display device including the liquid crystal composition of the present invention.

The present invention, by carrying out combination experiments on the compound and through comparison with controls, determines that the liquid crystal medium including the liquid crystal composition has characteristics of low viscosity, good low-temperature stability, high stability against ultraviolet rays, and high stability against heat.

If there is no special description in the present invention, the proportions are all weight ratios, all the temperatures are Celsius temperatures, and the thickness of the cell selected for data test of the response time is 7 μm.

### DETAILED DESCRIPTION OF THE INVENTION

The present invention is described below with reference to specific implementation solutions. It should be noted that the following embodiments are examples of the present invention, and are merely used to describe the present invention instead of limiting the present invention. Without departing from the main idea or scope of the present invention, other combinations and various improvements can be made within the concept of the present invention.

For ease of expression, in the following embodiments, a group structure of the liquid crystal composition is represented with codes listed in Table 1:

TABLE 1
Codes of the group structure of the liquid crystal composition

| Unit structure of the group | Code | Group name |
|---|---|---|
| 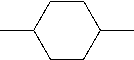 | C | 1,4-cyclohexylidene |
| 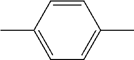 | P | 1,4-phenylene |
| 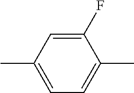 | G | 2-fluoro-1,4-phenylene |
| 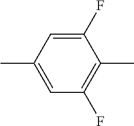 | U | 2,5-difluoro-1,4-phenylene |
| —C≡C— | T | alkynyl |
| —F | F | fluorinated substituent |
| —CF₂O— | 1(2F)O | difluoro ether |
| —CN | N | cyano |
| —COO— | E | ester bridge bond |
| —CnH₂ₙ₊₁ or —CₘH₂ₘ₊₁ | n or m | alkyl |

A compound of the following structural formula is used as an example:

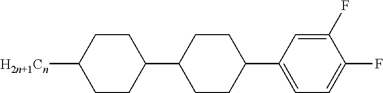

The structural formula, if represented with the codes listed in Table 1, can be expressed as: nCCGF, n in the code denotes the number of C atoms of alkyl on the left terminal, for example, if n is “3”, it indicates that the alkyl is —C₃H₇; and C in the code represents cyclohexane.

Abbreviated codes of test items in the following embodiments are as follows:
Cp (° C.): clearing point (a nematic-isotropic phase transition temperature)
Δn: optical anisotropy (589 nm, 20° C.)
Δε: dielectric anisotropy (1 KHz, 25° C.)
γ1: torsion viscosity (mPa*s, below 20° C.)
t_{-30° C.}: low temperature storage time (below −30° C.)
where anisotropy of a refractive index was obtained by using an abbe refractometer under a light source of sodium lamp (589 nm) at 20° C.; a dielectric test cell was Model TN90, and the cell thickness was 7 μm.

In the following embodiments, compounds of general formulas (I-1) and (II-12) and compounds of their sub-general formulas have been disclosed in CN102337139A, compounds of general formulas (II-13) and (II-14) and compounds of their sub-general formulas have been disclosed in CN102634346A, and other components used are synthesized by the inventor of the present application according to well-known methods or by properly combining methods in organic synthetic chemistry. The synthetic technologies are conventional, and liquid crystal compositions obtained, upon test, conform to standards of electronic compounds. Methods of introducing a target terminal group, a ring structure and a binding group into a starting material are described in publications such as Organic Syntheses (John Wiley & Sons, Inc), Organic Reactions (John Wiley & Sons, Inc), Comprehensive Organic Synthesis (Pergamon Press), and New Experimental Chemistry Lecture (Maruzen Co., Ltd.).

The liquid crystal composition was prepared according to proportions of liquid crystal compositions specified in the following embodiment. Preparation of the liquid crystal composition is carried out according to a conventional method in this field, for example, the liquid crystal composition was prepared by mixing according to specified proportions by means of heating, ultrasonic waves, suspension and the like.

The liquid crystal compositions given in the following embodiment were prepared and studied. The following show composition of the liquid crystal compositions and their performance parameter test results.

Table 2 and Table 3 listed components and proportions of liquid crystal compositions in control examples and test results of filling the liquid crystal compositions between two substrates of a liquid crystal display for performance tests, so as to facilitate performance contrast with the liquid crystal composition of the present invention.

### CONTROL EXAMPLE 1

The liquid crystal composition of the control example 1 was prepared according to compounds and weight percentages listed in Table 2 and was filled between two substrates of the liquid crystal display for a performance test, and test data is shown in the following table:

TABLE 2
Formulation of the liquid crystal composition and
test performance thereof

| | | Performance parameter | |
|---|---|---|---|
| Component code | Weight percentage | test result | |
| 2CCGF | 5 | Δn | 0.1061 |
| 3CCGF | 8 | Δε | 6.8 |
| 3CCP1 | 6 | Cp | 86.4 |
| 2CCPOCF3 | 3 | γ1 | 70.5 |
| 3CCPOCF3 | 3 | t_{-30° C.} | <144 h |
| 3CCV | 30 | | |
| 3CCV1 | 10 | | |
| 3CCPUF | 3 | | |
| 1PGP2V(2F) | 10 | | |
| 3PU1(2F)OUF | 5 | | |
| 3PGU1(2F)OUF | 10 | | |
| 4PGU1(2F)OUF | 7 | | |
| Total | 100 | | |

### CONTROL EXAMPLE 2

The liquid crystal composition of the control example 2 was prepared according to compounds and weight percentages listed in Table 3 and was filled between two substrates of the liquid crystal display for a performance test, and test data is shown in the following table:

TABLE 3
Formulation of the liquid crystal composition and
test performance thereof

| | | Performance parameter | |
|---|---|---|---|
| Component code | Weight percentage | test result | |
| 3CPGF | 2 | Δn | 0.1103 |
| 2CCGF | 5 | Δε | 5.7 |
| 3CCGF | 4 | Cp | 84.6 |
| 3CCP1 | 6 | γ1 | 83.3 |
| 2CCPOCF3 | 4 | t_{-30° C.} | >240 h |
| 3CCPOCF3 | 2 | | |
| 3CCV | 32 | | |
| 3CCV1 | 11 | | |
| 2PGP3 | 6 | | |
| 5PGP2 | 6 | | |
| 2IU1(2F)OUF | 4 | | |
| 3IU1(2F)OUF | 5 | | |
| 3IGU1(2F)OUF | 7 | | |
| 2IGU1(2F)OUF | 6 | | |
| Total | 100 | | |

### Embodiment 1

The liquid crystal composition of Embodiment 1 was prepared according to compounds and weight percentages listed in Table 4 and was filled between two substrates of the liquid crystal display for a performance test, and test data is shown in the following table:

TABLE 4
Formulation of the liquid crystal composition and
test performance thereof

| | | Performance parameter | |
|---|---|---|---|
| Component code | Weight percentage | test result | |
| 3CPP2 | 5 | Δn | 0.1149 |
| 3CGPC3 | 2 | Δε | 4 |
| 3CPGF | 2 | Cp | 76 |
| 3CCV | 52 | γ1 | 68.7 |
| 3CCV1 | 3 | t_{-30° C.} | >240 h |
| 1PGP2V(2F) | 6 | | |
| 2PGP2V(2F) | 6 | | |
| 3PGP2V(2F) | 6 | | |
| 2IU1(2F)OUF | 4 | | |
| 2IGU1(2F)OUF | 7 | | |
| 3IGU1(2F)OUF | 7 | | |
| Total | 100 | | |

### Embodiment 2

The liquid crystal composition of Embodiment 2 was prepared according to compounds and weight percentages listed in Table 5 and was filled between two substrates of the liquid crystal display for a performance test, and test data is shown in the following table:

TABLE 5
Formulation of the liquid crystal composition and
test performance thereof

| | | Performance parameter | |
|---|---|---|---|
| Component code | Weight percentage | test result | |
| 2CCGF | 5 | Δn | 0.1065 |
| 3CCGF | 5 | Δε | 6.9 |
| 3CCP1 | 6 | Cp | 86.7 |
| 2CCPOCF3 | 3 | γ1 | 70.2 |
| 3CCPOCF3 | 3 | t_{-30° C.} | >240 h |
| 3CPGF | 3 | | |
| 3CCV | 30 | | |
| 3CCV1 | 10 | | |
| 3CCPUF | 3 | | |
| 1PGP2V(2F) | 6 | | |
| 2PGP2V(2F) | 4 | | |
| 3PU1(2F)OUF | 5 | | |
| 3PGU1(2F)OUF | 10 | | |
| 4PGU1(2F)OUF | 7 | | |
| Total | 100 | | |

### Embodiment 3

The liquid crystal composition of Embodiment 3 was prepared according to compounds and weight percentages listed in Table 6 and was filled between two substrates of the liquid crystal display for a performance test, and test data is shown in the following table:

TABLE 6
Formulation of the liquid crystal composition and
test performance thereof

| | | Performance parameter | |
|---|---|---|---|
| Component code | Weight percentage | test result | |
| | 3 | Δn | 0.109 |
| 3CCGF | 4 | Δε | 5.6 |
| 3CCP1 | 4 | Cp | 84 |
| 3CCP2 | 4 | γ1 | 74.4 |
| 2CCPOCF3 | 4 | t_{-30° C.} | >240 h |
| 3CCPOCF3 | 2 | | |
| 3CCV | 34 | | |
| 3CCV1 | 11 | | |
| 1PGP2V(2F) | 6 | | |
| 2PGP2V(2F) | 6 | | |
| 2IU1(2F)OUF | 4 | | |
| 3IU1(2F)OUF | 5 | | |
| 2IGU1(2F)OUF | 7 | | |
| 3IGU1(2F)OUF | 6 | | |
| Total | 100 | | |

### Embodiment 4

The liquid crystal composition of Embodiment 4 was prepared according to compounds and weight percentages listed in Table 7 and was filled between two substrates of the liquid crystal display for a performance test, and test data is shown in the following table:

TABLE 7
Formulation of the liquid crystal composition and
test performance thereof

| | | Performance parameter | |
|---|---|---|---|
| Component code | Weight percentage | test result | |
| 3CCUF | 7 | Δn | 0.115 |
| 3CPUF | 10 | Δε | 4.2 |
| 3PGUF | 4 | Cp | 75.5 |
| VCCP1 | 4 | γ1 | 60.6 |
| 3CCV | 45 | t_{-30° C.} | >240 h |
| 1PGP2V(2F) | 6 | | |
| 2PGP2V(2F) | 6 | | |
| 3PGP2V(2F) | 5 | | |
| 3PU1(2F)OUF | 4 | | |
| 3PGU1(2F)OUF | 4 | | |
| 3CCGUF | 5 | | |
| Total | 100 | | |

### Embodiment 5

The liquid crystal composition of Embodiment 5 was prepared according to compounds and weight percentages listed in Table 8 and was filled between two substrates of the liquid crystal display for a performance test, and test data is shown in the following table:

TABLE 8
Formulation of the liquid crystal composition and
test performance thereof

| | | Performance parameter | |
|---|---|---|---|
| Component code | Weight percentage | test result | |
| 2CCGF | 6 | Δn | 0.11 |
| 3CCGF | 9 | Δε | 6.8 |
| 3CCP1 | 4 | Cp | 86.8 |
| 3CCP2 | 5 | γ1 | 73.8 |
| 2CCPOCF3 | 3 | t_{-30° C.} | >240 h |
| 3CCPOCF3 | 3 | | |
| 3CCV | 30 | | |
| 3CCV1 | 8 | | |
| 3CCPUF | 3 | | |
| 1PGP2V(2F) | 7 | | |
| 3PU1(2F)OUF | 5 | | |
| 3PGU1(2F)OUF | 10 | | |
| 4PGU1(2F)OUF | 7 | | |
| Total | 100 | | |

### Embodiment 6

The liquid crystal composition of Embodiment 6 was prepared according to compounds and weight percentages listed in Table 9 and was filled between two substrates of the liquid crystal display for a performance test, and test data is shown in the following table:

TABLE 9
Formulation of the liquid crystal composition and
test performance thereof

| | | Performance parameter | |
|---|---|---|---|
| Component code | Weight percentage | test result | |
| 2CCGF | 5 | Δn | 0.1035 |
| 3CCGF | 8 | Δε | 6.7 |
| 3CCP1 | 6 | Cp | 85.8 |
| 2CCPOCF3 | 4 | γ1 | 72.1 |
| 3CCPOCF3 | 4 | t_{-30° C.} | >240 h |
| 3CCV | 30 | | |
| 3CCV1 | 10 | | |
| 3CCPUF | 3 | | |
| 3PGP2V(2F) | 8 | | |
| 3PU1(2F)OUF | 5 | | |
| 3PGU1(2F)OUF | 10 | | |
| 4PGU1(2F)OUF | 7 | | |
| Total | 100 | | |

### Embodiment 7

The liquid crystal composition of Embodiment 7 was prepared according to compounds and weight percentages listed in Table 10 and was filled between two substrates of the liquid crystal display for a performance test, and test data is shown in the following table:

TABLE 10
Formulation of the liquid crystal composition and
test performance thereof

| | | |
|---|---|---|
| | | Performance parameter |
| Component code | Weight percent | test result |

| | | | |
|---|---|---|---|
| 2CCGF | 6 | Δn | 0.0998 |
| 3CCGF | 8 | Δε | 6.7 |
| 3CCP1 | 7 | Cp | 84.3 |
| 2CCPOCF3 | 5 | γ1 | 70.7 |
| 3CCPOCF3 | 5 | t_{-30° C.} | >240 h |
| 3CCV | 30 | | |
| 3CCV1 | 10 | | |
| 3CCPUF | 3 | | |
| 2PGP2V(2F) | 4 | | |
| 3PU1(2F)OUF | 5 | | |
| 3PGU1(2F)OUF | 10 | | |
| 4PGU1(2F)OUF | 7 | | |
| Total | 100 | | |

With reference to control examples 1 and 2, it can be seen from the test data of the embodiments 1, 2, 3, 4, 5, 6 and 7 that the liquid crystal composition provided in the present invention has at least one prominent characteristic in the characteristics of small viscosity, good low-temperature stability, high stability against ultraviolet rays, high stability against heat and the like, and is applicable to liquid crystal display modes such as TN and IPS.

What is claimed is:

1. A liquid crystal composition, comprising:
at least one compound of general formula I that accounts for 1-30% of the total weight of the liquid crystal composition: 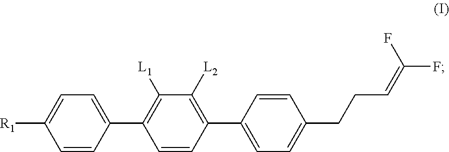
at least one polar compound of general formula II that accounts for 5-75% of the total weight of the liquid crystal composition: 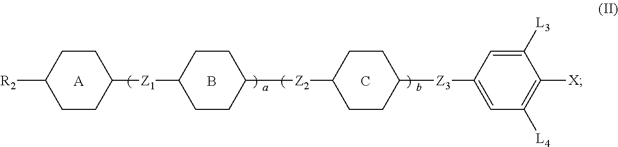
at least one compound of general formula III that accounts for 0-25% of the total weight of the liquid crystal composition: 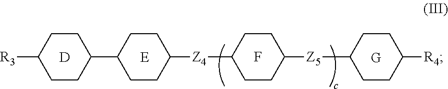
and
at least one compound of general formula IV that accounts for 5-75% of the total weight of the liquid crystal composition: 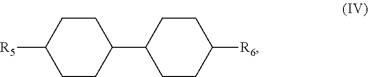
wherein:
R₁, R₂, R₃, R₄, R₅ and R₆ are the same or different, respectively independently selected from a group consisting of alkyl or alkoxy of which the number of carbon atoms is 1-15 and alkenyl or alkenoxy of which the number of carbon atoms is 2-15;
L₁, L₂, L₃ and L₄ are the same or different, respectively independently being H or F, and at least one of L₁ and L₂ is F; 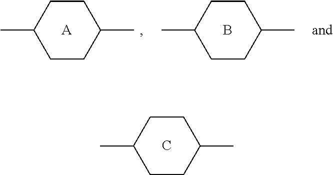
are the same or different, respectively independently selected from a group consisting of 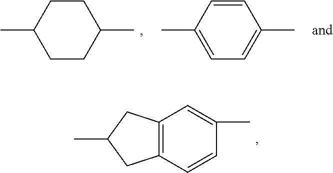
wherein one or more H in 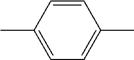
can be independently replaced by F; 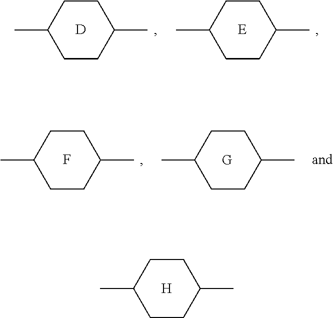
are the same or different, respectively independently selected from a group consisting of 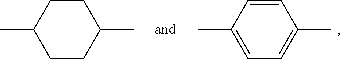
wherein one or more H in 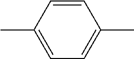
can be independently replaced by F;
X denotes F, Cl, CN, or fluoroalkyl or fluoroalkoxy of which the number of carbon atoms is 1 to 5;
Z₁, Z₂, Z₃, Z₄ and Z₅ are the same or different, respectively independently selected from a group consisting of a C—C single bond, —COO—, —OCO—, —CF₂O—, —CH₂O—, —CH₂CH₂—, —CF₂CH₂—, —CF═CF—, —CH═CH—, —CH═CF—, —C₂F₄—, —(CH₂)₄—, —(CF₂)₄—, —OCF₂CF₂O—, —CF₂CF₂CF₂O—, —CH₂CH₂CF₂O—, —OCH₂CF₂O—, —OCF₂CH₂O—, —CH₂CF₂OCH₂—, —CH═CHCF₂O—, —CF₂OCH═CH—, —CF₂OCF═CH—, —CF₂OCH═CF—, —CF═CFCF₂O—, —CF₂OCF═CF—, —C₂H₄OCH₂—, —CH═CHCH₂CH₂—, —CH₂CH═CHCH₂—, —OCH₂CH₂CH₂—, —CF═CF—CF═CF—, —C≡C—, —C≡C—CF═CF—, —C≡C—CF═CF—C≡C—, —CF═CF—C≡C—CF═CF—, and —C≡C—CF₂O—; and
a, b and c are the same or different, respectively independently indicating 0, 1 or 2.

2. The liquid crystal composition according to claim 1, wherein the liquid crystal composition comprises at least two compounds of the general formula I, which account for 2-30% of the total weight of the liquid crystal composition.

3. The liquid crystal composition according to claim 1, wherein the liquid crystal composition only comprises one compound of the general formula I, which accounts for 1-8% of the total weight of the liquid crystal composition.

4. The liquid crystal composition according to claim 2, wherein the compound of the general formula I is selected from one or more compounds in a group consisting of compounds of general formula I-1: 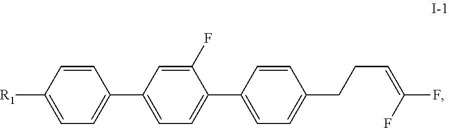
wherein:
the R₁ is selected from a group consisting of alkyl or alkoxy of which the number of carbon atoms is 1-7 and alkenyl or alkenoxy of which the number of carbon atoms is 2-7.

5. The liquid crystal composition according to claim 2, wherein the compound of the general formula II is selected from one or more compounds in a group consisting of the following compounds: 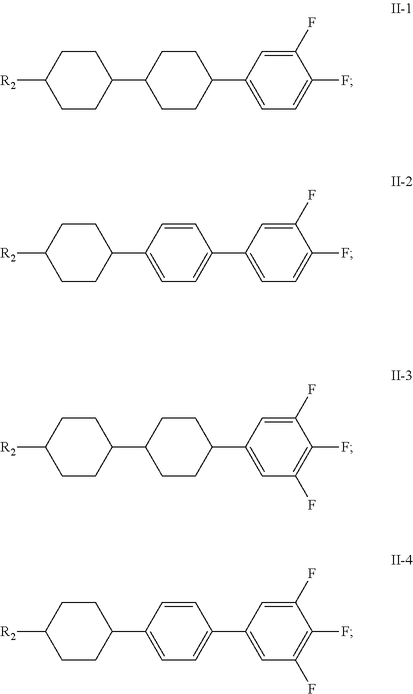 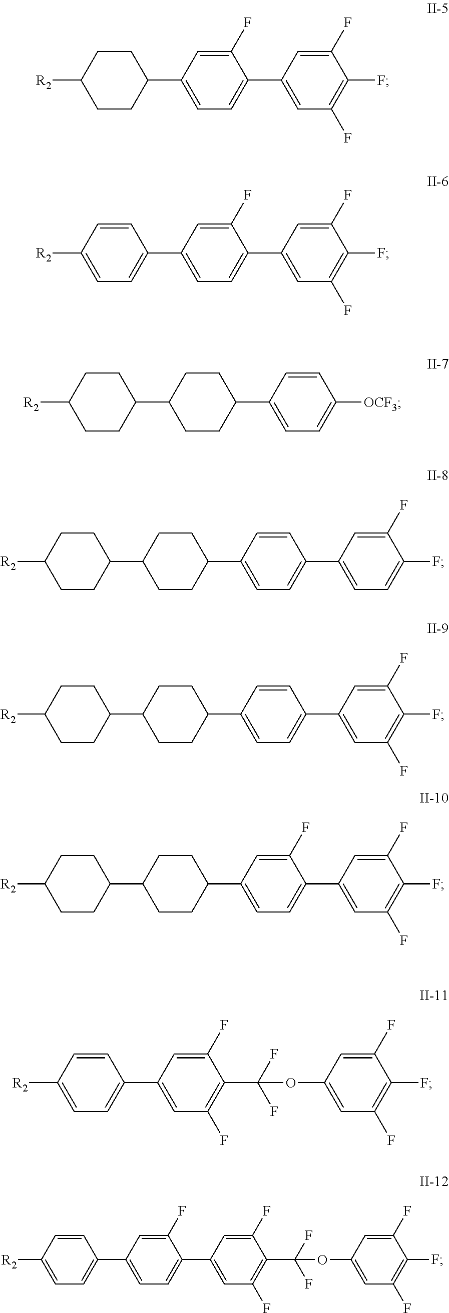 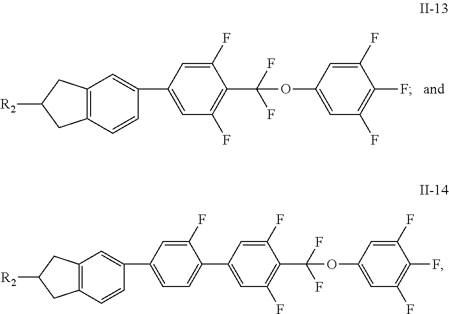
wherein:
the R₂ is selected from a group consisting of alkyl or alkoxy of which the number of carbon atoms is 1-7 and alkenyl or alkenoxy of which the number of carbon atoms is 2-7.

6. The liquid crystal composition according to claim 2, wherein the compound of the general formula III is selected from one or more compounds in a group consisting of the following compounds: 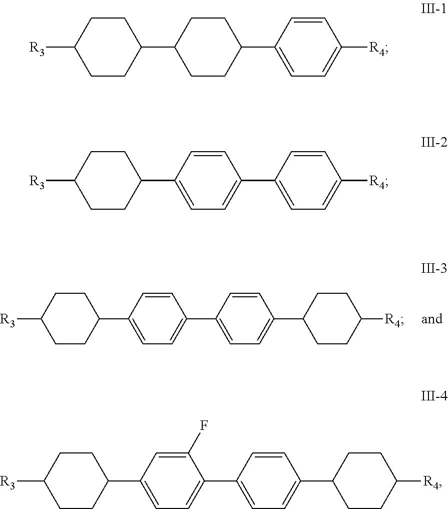
wherein: the R₃ and the R₄ are the same or different, respectively independently indicating alkyl or alkoxy of which the number of carbon atoms is 1-7, or alkenyl of which the number of carbon atoms is 2-7.

7. The liquid crystal composition according to claim 2, wherein the compound of the general formula IV is selected from one or more compounds in a group consisting of the following compounds: 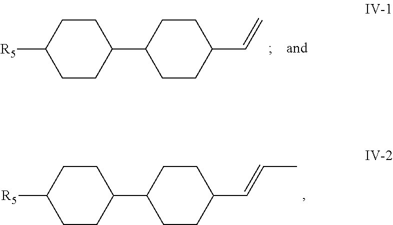
wherein: the R₅ is selected from a group consisting of alkyl of which the number of carbon atoms is 1-7 and alkoxy of which the number of carbon atoms is 1-7.

8. The liquid crystal composition according to claim 4, wherein the liquid crystal composition comprises:
a compound that accounts for 5% of the total weight of the liquid crystal composition: 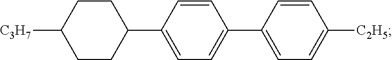
a compound that accounts for 2% of the total weight of the liquid crystal composition: 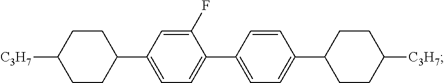
a compound that accounts for 2% of the total weight of the liquid crystal composition: 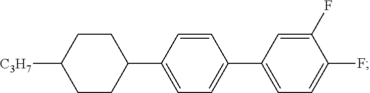
a compound that accounts for 52% of the total weight of the liquid crystal composition: 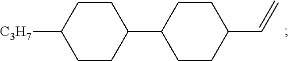
a compound that accounts for 3% of the total weight of the liquid crystal composition: 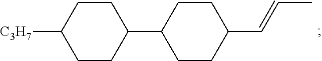
a compound that accounts for 6% of the total weight of the liquid crystal composition: 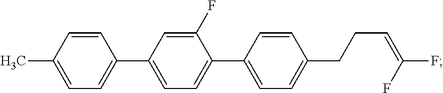 [SMILES: Cc1ccc(-c2ccc(-c3ccc(CCC=C(F)F)cc3)c(F)c2)cc1]
a compound that accounts for 6% of the total weight of the liquid crystal composition: 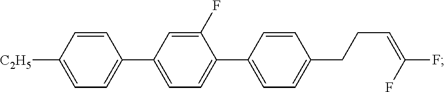 [SMILES: CCc1ccc(-c2ccc(-c3ccc(CCC=C(F)F)cc3)c(F)c2)cc1]
a compound that accounts for 6% of the total weight of the liquid crystal composition: 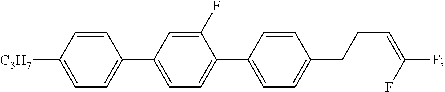
a compound that accounts for 4% of the total weight of the liquid crystal composition: 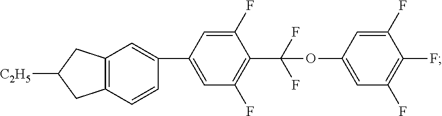 [SMILES: CCC1Cc2ccc(-c3cc(F)c(C(F)(F)Oc4cc(F)c(F)c(F)c4)c(F)c3)cc2C1]
a compound that accounts for 7% of the total weight of the liquid crystal composition: 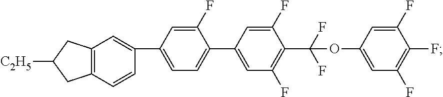 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 7% of the total weight of the liquid crystal composition: 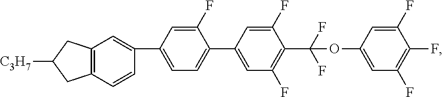
or the liquid crystal composition comprises:
a compound that accounts for 2% of the total weight of the liquid crystal composition: 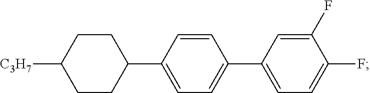
a compound that accounts for 6% of the total weight of the liquid crystal composition: 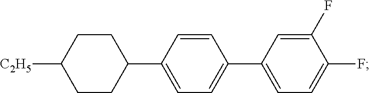 [SMILES: CCC1CCC(c2ccc(-c3ccc(F)c(F)c3)cc2)CC1]
a compound that accounts for 6% of the total weight of the liquid crystal composition: 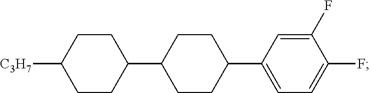
a compound that accounts for 6% of the total weight of the liquid crystal composition: 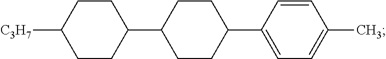
a compound that accounts for 4% of the total weight of the liquid crystal composition: 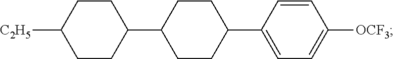 [SMILES: CCC1CCC(C2CCC(c3ccc(OC(F)(F)F)cc3)CC2)CC1]
a compound that accounts for 2% of the total weight of the liquid crystal composition: 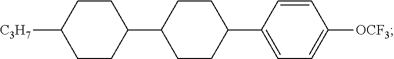
a compound that accounts for 34% of the total weight of the liquid crystal composition: 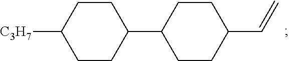
a compound that accounts for 11% of the total weight of the liquid crystal composition: 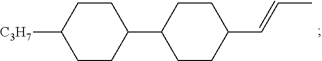
a compound that accounts for 7% of the total weight of the liquid crystal composition: 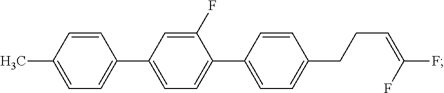 [SMILES: Cc1ccc(-c2ccc(-c3ccc(CCC=C(F)F)cc3)c(F)c2)cc1]
a compound that accounts for 4% of the total weight of the liquid crystal composition: 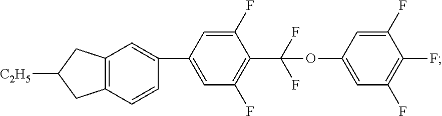 [SMILES: CCC1Cc2ccc(-c3cc(F)c(C(F)(F)Oc4cc(F)c(F)c(F)c4)c(F)c3)cc2C1]
a compound that accounts for 5% of the total weight of the liquid crystal composition: 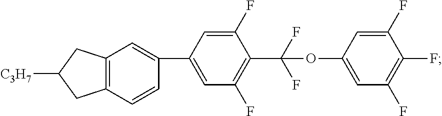
a compound that accounts for 6% of the total weight of the liquid crystal composition: 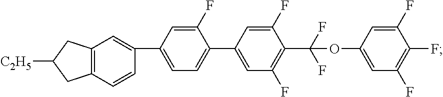 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 7% of the total weight of the liquid crystal composition: 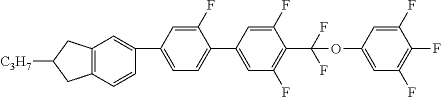
or the liquid crystal composition comprises:
a compound that accounts for 3% of the total weight of the liquid crystal composition: 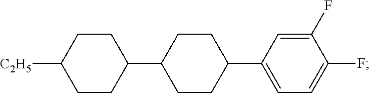 [SMILES: CCC1CCC(C2CCC(c3ccc(F)c(F)c3)CC2)CC1]
a compound that accounts for 4% of the total weight of the liquid crystal composition: 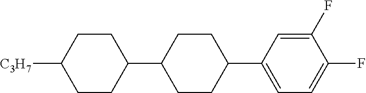
a compound that accounts for 4% of the total weight of the liquid crystal composition: 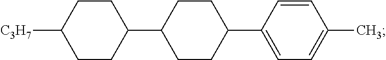
a compound that accounts for 4% of the total weight of the liquid crystal composition: 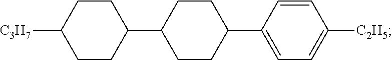
a compound that accounts for 4% of the total weight of the liquid crystal composition: 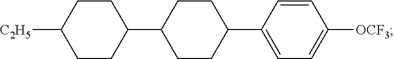 [SMILES: CCC1CCC(C2CCC(c3ccc(OC(F)(F)F)cc3)CC2)CC1]
a compound that accounts for 2% of the total weight of the liquid crystal composition: 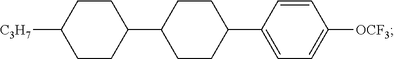
a compound that accounts for 34% of the total weight of the liquid crystal composition: 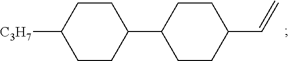
a compound that accounts for 11% of the total weight of the liquid crystal composition: 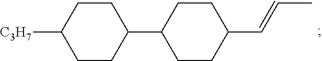
a compound that accounts for 6% of the total weight of the liquid crystal composition: 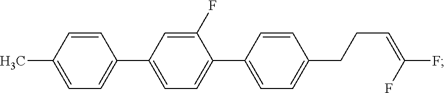 [SMILES: Cc1ccc(-c2ccc(-c3ccc(CCC=C(F)F)cc3)c(F)c2)cc1]
a compound that accounts for 6% of the total weight of the liquid crystal composition: 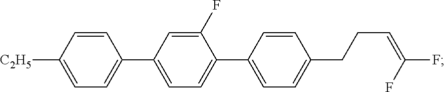 [SMILES: CCc1ccc(-c2ccc(-c3ccc(CCC=C(F)F)cc3)c(F)c2)cc1]
a compound that accounts for 4% of the total weight of the liquid crystal composition: 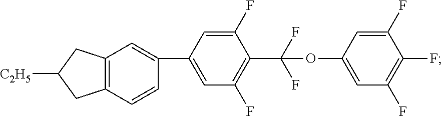 [SMILES: CCC1Cc2ccc(-c3cc(F)c(C(F)(F)Oc4cc(F)c(F)c(F)c4)c(F)c3)cc2C1]
a compound that accounts for 5% of the total weight of the liquid crystal composition: 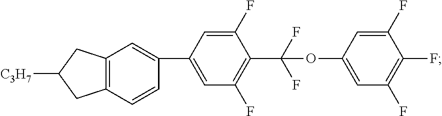
a compound that accounts for 7% of the total weight of the liquid crystal composition: 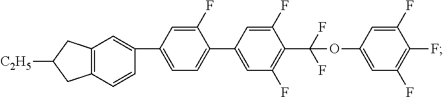 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 6% of the total weight of the liquid crystal composition: 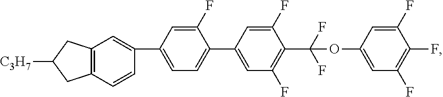
or the liquid crystal composition comprises:
a compound that accounts for 7% of the total weight of the liquid crystal composition: 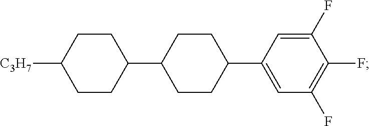
a compound that accounts for 10% of the total weight of the liquid crystal composition: 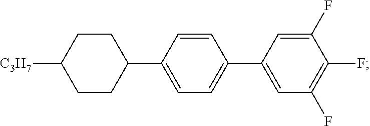
a compound that accounts for 4% of the total weight of the liquid crystal composition: 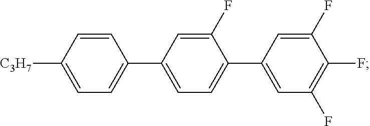
a compound that accounts for 4% of the total weight of the liquid crystal composition: 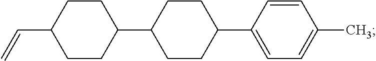 [SMILES: C=CC1CCC(C2CCC(c3ccc(C)cc3)CC2)CC1]
a compound that accounts for 45% of the total weight of the liquid crystal composition: 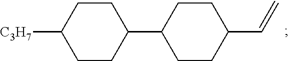
a compound that accounts for 6% of the total weight of the liquid crystal composition: 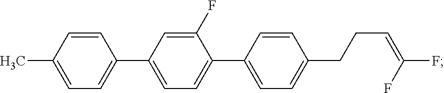 [SMILES: Cc1ccc(-c2ccc(-c3ccc(CCC=C(F)F)cc3)c(F)c2)cc1]
a compound that accounts for 6% of the total weight of the liquid crystal composition: 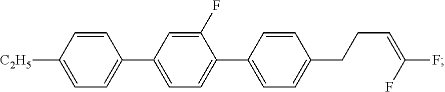 [SMILES: CCc1ccc(-c2ccc(-c3ccc(CCC=C(F)F)cc3)c(F)c2)cc1]
a compound that accounts for 5% of the total weight of the liquid crystal composition: 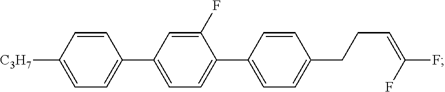
a compound that accounts for 4% of the total weight of the liquid crystal composition: 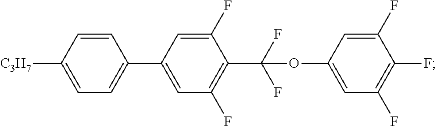
a compound that accounts for 4% of the total weight of the liquid crystal composition: 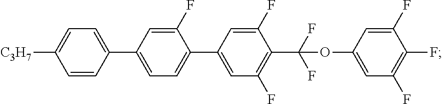
and
a compound that accounts for 5% of the total weight of the liquid crystal composition: 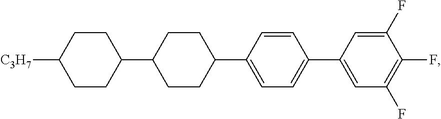
or the liquid crystal composition comprises:
a compound that accounts for 6% of the total weight of the liquid crystal composition: 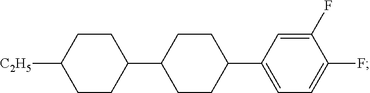 [SMILES: CCC1CCC(C2CCC(c3ccc(F)c(F)c3)CC2)CC1]
a compound that accounts for 9% of the total weight of the liquid crystal composition: 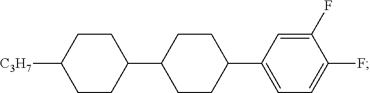
a compound that accounts for 4% of the total weight of the liquid crystal composition: 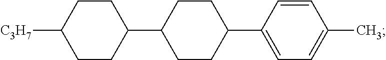
a compound that accounts for 5% of the total weight of the liquid crystal composition: 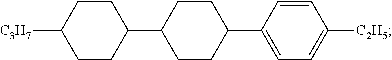
a compound that accounts for 3% of the total weight of the liquid crystal composition: 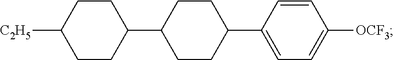 [SMILES: CCC1CCC(C2CCC(c3ccc(OC(F)(F)F)cc3)CC2)CC1]
a compound that accounts for 3% of the total weight of the liquid crystal composition: 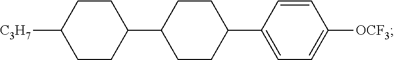
a compound that accounts for 30% of the total weight of the liquid crystal composition: 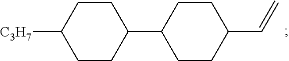
a compound that accounts for 8% of the total weight of the liquid crystal composition: 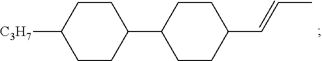
a compound that accounts for 3% of the total weight of the liquid crystal composition: 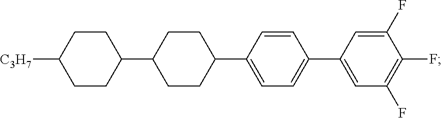
a compound that accounts for 7% of the total weight of the liquid crystal composition: 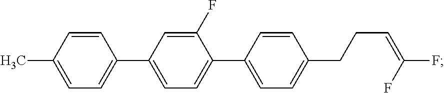 [SMILES: Cc1ccc(-c2ccc(-c3ccc(CCC=C(F)F)cc3)c(F)c2)cc1]
a compound that accounts for 5% of the total weight of the liquid crystal composition: 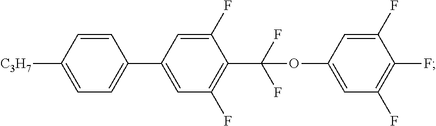
a compound that accounts for 10% of the total weight of the liquid crystal composition: 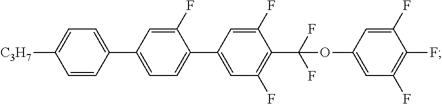
and
a compound that accounts for 7% of the total weight of the liquid crystal composition: 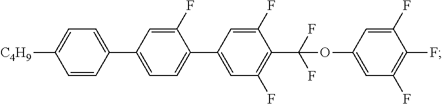
or the liquid crystal composition comprises:
a compound that accounts for 5% of the total weight of the liquid crystal composition: 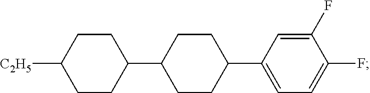 [SMILES: CCC1CCC(C2CCC(c3ccc(F)c(F)c3)CC2)CC1]
a compound that accounts for 8% of the total weight of the liquid crystal composition: 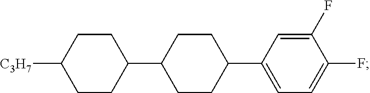
a compound that accounts for 6% of the total weight of the liquid crystal composition: 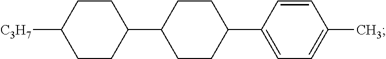
a compound that accounts for 4% of the total weight of the liquid crystal composition: 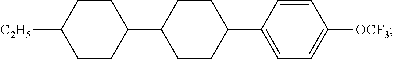 [SMILES: CCC1CCC(C2CCC(c3ccc(OC(F)(F)F)cc3)CC2)CC1]
a compound that accounts for 4% of the total weight of the liquid crystal composition: 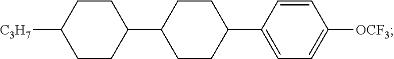
a compound that accounts for 30% of the total weight of the liquid crystal composition: 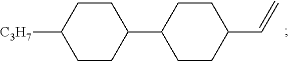
a compound that accounts for 10% of the total weight of the liquid crystal composition: 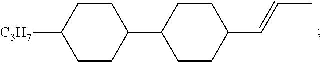
a compound that accounts for 3% of the total weight of the liquid crystal composition: 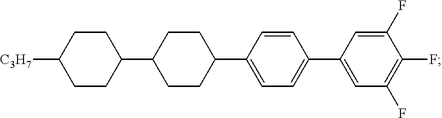
a compound that accounts for 8% of the total weight of the liquid crystal composition: 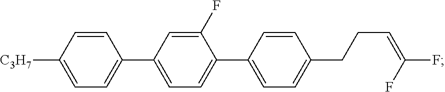
a compound that accounts for 5% of the total weight of the liquid crystal composition: 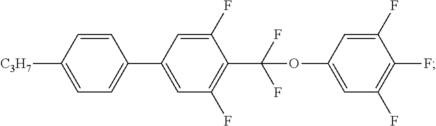
a compound that accounts for 10% of the total weight of the liquid crystal composition: 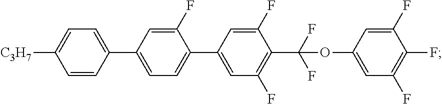
and
a compound that accounts for 7% of the total weight of the liquid crystal composition: 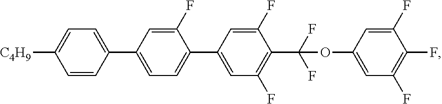
or the liquid crystal composition comprises:
a compound that accounts for 6% of the total weight of the liquid crystal composition: 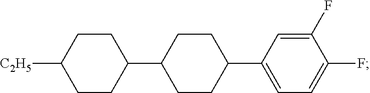 [SMILES: CCC1CCC(C2CCC(c3ccc(F)c(F)c3)CC2)CC1]
a compound that accounts for 8% of the total weight of the liquid crystal composition: 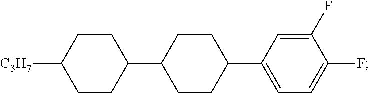
a compound that accounts for 7% of the total weight of the liquid crystal composition: 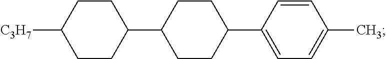
a compound that accounts for 5% of the total weight of the liquid crystal composition: 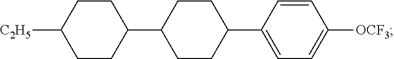 [SMILES: CCC1CCC(C2CCC(c3ccc(OC(F)(F)F)cc3)CC2)CC1]
a compound that accounts for 5% of the total weight of the liquid crystal composition: 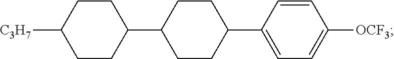
a compound that accounts for 30% of the total weight of the liquid crystal composition: 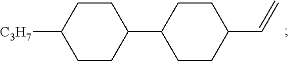
a compound that accounts for 10% of the total weight of the liquid crystal composition: 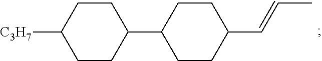
a compound that accounts for 3% of the total weight of the liquid crystal composition: 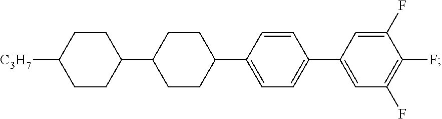
a compound that accounts for 4% of the total weight of the liquid crystal composition: 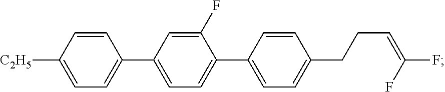 [SMILES: CCc1ccc(-c2ccc(-c3ccc(CCC=C(F)F)cc3)c(F)c2)cc1]
a compound that accounts for 5% of the total weight of the liquid crystal composition: 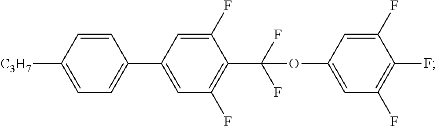
a compound that accounts for 10% of the total weight of the liquid crystal composition: 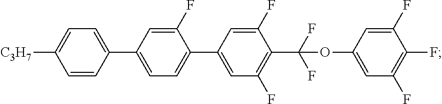
and
a compound that accounts for 7% of the total weight of the liquid crystal composition:

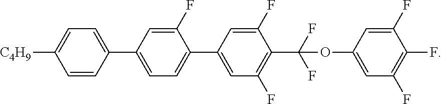

9. A liquid crystal display device, comprising the liquid crystal composition according to claim 1.

10. The liquid crystal composition according to claim 3, wherein the compound of the general formula I is selected from one or more compounds in a group consisting of compounds of general formula I-1: 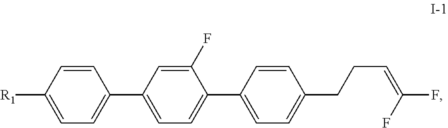
wherein:
the R₁ is selected from a group consisting of alkyl or alkoxy of which the number of carbon atoms is 1-7 and alkenyl or alkenoxy of which the number of carbon atoms is 2-7.

11. The liquid crystal composition according to claim 3, wherein the compound of the general formula II is selected from one or more compounds in a group consisting of the following compounds: 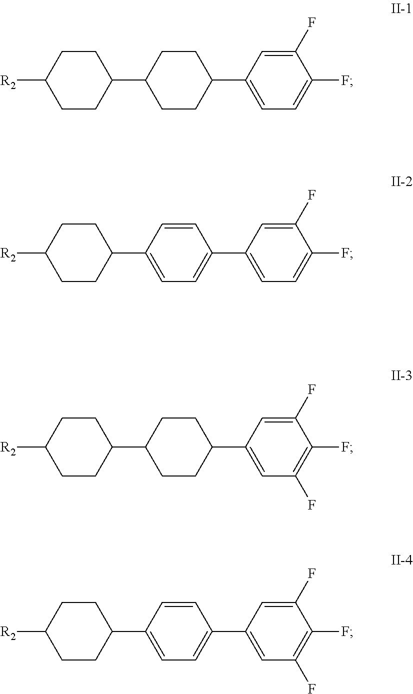 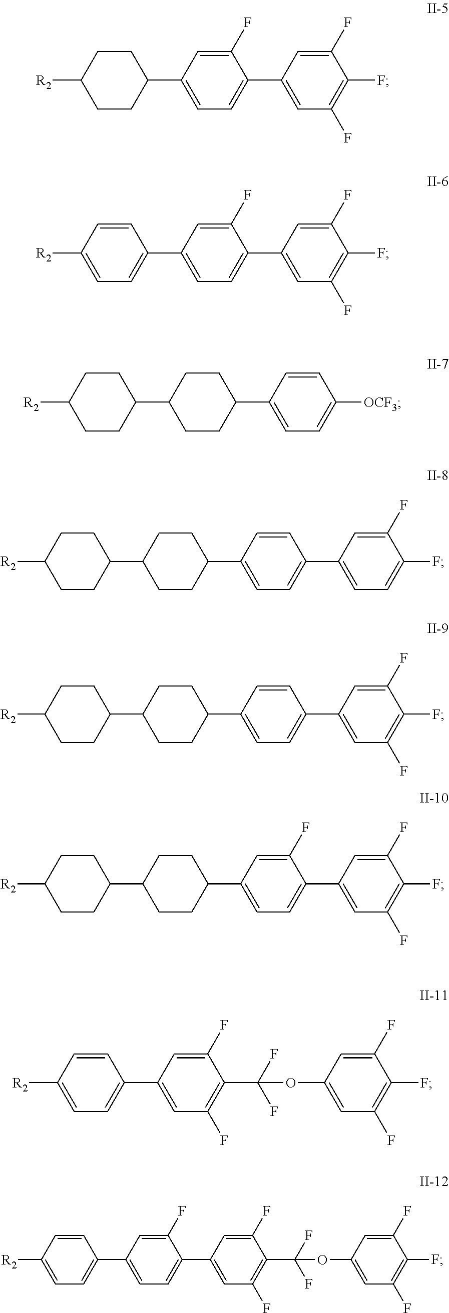 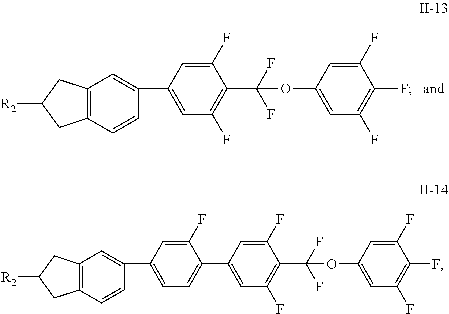
wherein:
the R₂ is selected from a group consisting of alkyl or alkoxy of which the number of carbon atoms is 1-7 and alkenyl or alkenoxy of which the number of carbon atoms is 2-7.

12. The liquid crystal composition according to claim 3, wherein the compound of the general formula III is selected from one or more compounds in a group consisting of the following compounds: 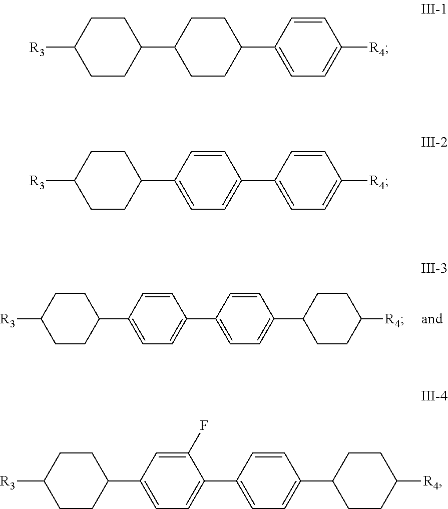
wherein:
the R₃ and the R₄ are the same or different, respectively independently indicating alkyl or alkoxy of which the number of carbon atoms is 1-7, or alkenyl of which the number of carbon atoms is 2-7.

13. The liquid crystal composition according to claim 3, wherein the compound of the general formula IV is selected from one or more compounds in a group consisting of the following compounds: 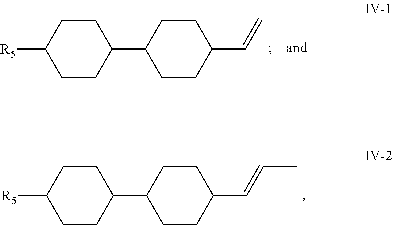
wherein:
the R₅ is selected from a group consisting of alkyl of which the number of carbon atoms is 1-7 and alkoxy of which the number of carbon atoms is 1-7.

14. The liquid crystal composition according to claim 10, wherein the liquid crystal composition comprises:
a compound that accounts for 5% of the total weight of the liquid crystal composition: 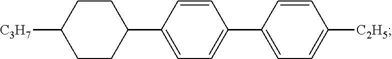
a compound that accounts for 2% of the total weight of the liquid crystal composition: 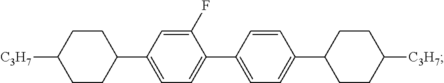
a compound that accounts for 2% of the total weight of the liquid crystal composition: 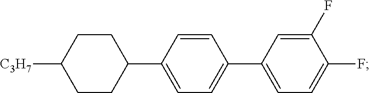
a compound that accounts for 52% of the total weight of the liquid crystal composition: 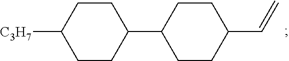
a compound that accounts for 3% of the total weight of the liquid crystal composition: 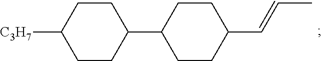
a compound that accounts for 6% of the total weight of the liquid crystal composition: 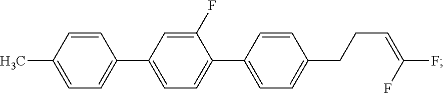 [SMILES: Cc1ccc(-c2ccc(-c3ccc(CCC=C(F)F)cc3)c(F)c2)cc1]
a compound that accounts for 6% of the total weight of the liquid crystal composition: 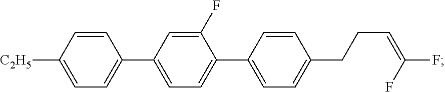 [SMILES: CCc1ccc(-c2ccc(-c3ccc(CCC=C(F)F)cc3)c(F)c2)cc1]
a compound that accounts for 6% of the total weight of the liquid crystal composition: 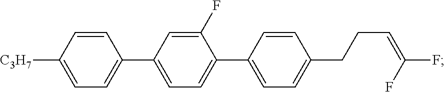
a compound that accounts for 4% of the total weight of the liquid crystal composition: 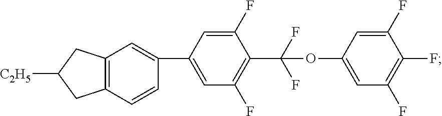 [SMILES: CCC1Cc2ccc(-c3cc(F)c(C(F)(F)Oc4cc(F)c(F)c(F)c4)c(F)c3)cc2C1]
a compound that accounts for 7% of the total weight of the liquid crystal composition: 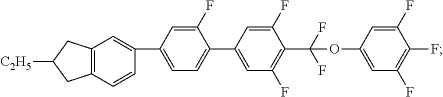 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 7% of the total weight of the liquid crystal composition: 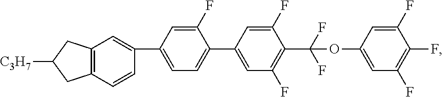
or the liquid crystal composition comprises:
a compound that accounts for 2% of the total weight of the liquid crystal composition: 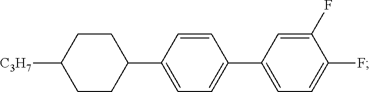
a compound that accounts for 6% of the total weight of the liquid crystal composition: 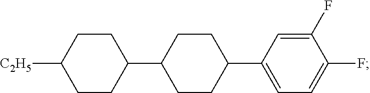 [SMILES: CCC1CCC(C2CCC(c3ccc(F)c(F)c3)CC2)CC1]
a compound that accounts for 6% of the total weight of the liquid crystal composition: 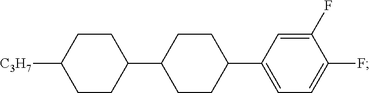
a compound that accounts for 6% of the total weight of the liquid crystal composition: 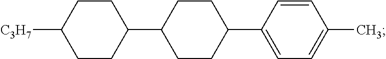
a compound that accounts for 4% of the total weight of the liquid crystal composition: 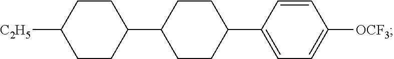 [SMILES: CCC1CCC(C2CCC(c3ccc(OC(F)(F)F)cc3)CC2)CC1]
a compound that accounts for 2% of the total weight of the liquid crystal composition: 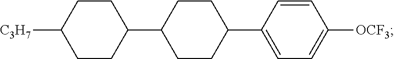
a compound that accounts for 34% of the total weight of the liquid crystal composition: 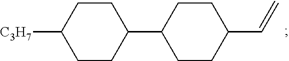
a compound that accounts for 11% of the total weight of the liquid crystal composition: 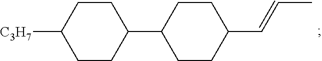
a compound that accounts for 7% of the total weight of the liquid crystal composition: 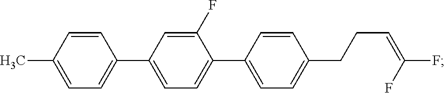 [SMILES: Cc1ccc(-c2ccc(-c3ccc(CCC=C(F)F)cc3)c(F)c2)cc1]
a compound that accounts for 4% of the total weight of the liquid crystal composition: 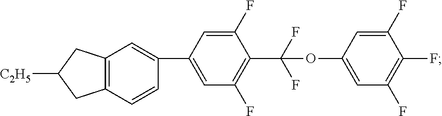 [SMILES: CCC1Cc2ccc(-c3cc(F)c(C(F)(F)Oc4cc(F)c(F)c(F)c4)c(F)c3)cc2C1]
a compound that accounts for 5% of the total weight of the liquid crystal composition: 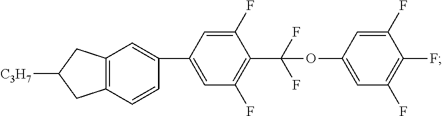
a compound that accounts for 6% of the total weight of the liquid crystal composition: 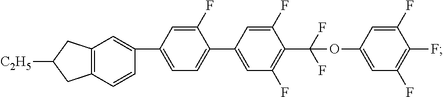 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 7% of the total weight of the liquid crystal composition: 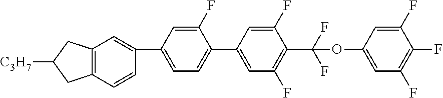
or the liquid crystal composition comprises:
a compound that accounts for 3% of the total weight of the liquid crystal composition: 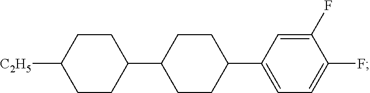 [SMILES: CCC1CCC(C2CCC(c3ccc(F)c(F)c3)CC2)CC1]
a compound that accounts for 4% of the total weight of the liquid crystal composition: 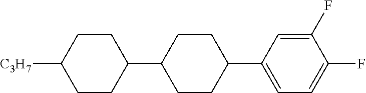
a compound that accounts for 4% of the total weight of the liquid crystal composition: 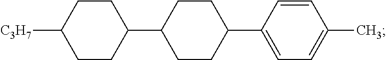
a compound that accounts for 4% of the total weight of the liquid crystal composition: 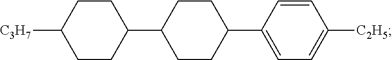
a compound that accounts for 4% of the total weight of the liquid crystal composition: 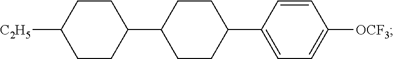 [SMILES: CCC1CCC(C2CCC(c3ccc(OC(F)(F)F)cc3)CC2)CC1]
a compound that accounts for 2% of the total weight of the liquid crystal composition: 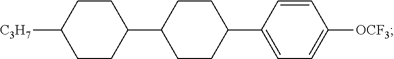
a compound that accounts for 34% of the total weight of the liquid crystal composition: 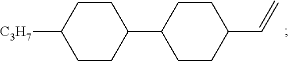
a compound that accounts for 11% of the total weight of the liquid crystal composition: 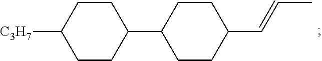
a compound that accounts for 6% of the total weight of the liquid crystal composition: 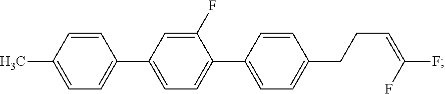 [SMILES: Cc1ccc(-c2ccc(-c3ccc(CCC=C(F)F)cc3)c(F)c2)cc1]
a compound that accounts for 6% of the total weight of the liquid crystal composition: 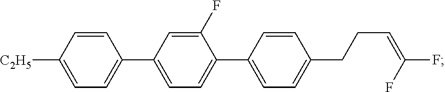 [SMILES: CCc1ccc(-c2ccc(-c3ccc(CCC=C(F)F)cc3)c(F)c2)cc1]
a compound that accounts for 4% of the total weight of the liquid crystal composition: 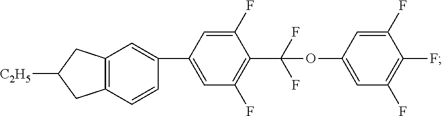 [SMILES: CCC1Cc2ccc(-c3cc(F)c(C(F)(F)Oc4cc(F)c(F)c(F)c4)c(F)c3)cc2C1]
a compound that accounts for 5% of the total weight of the liquid crystal composition: 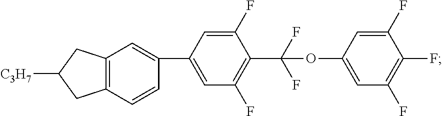
a compound that accounts for 7% of the total weight of the liquid crystal composition: 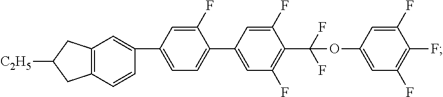 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 6% of the total weight of the liquid crystal composition: 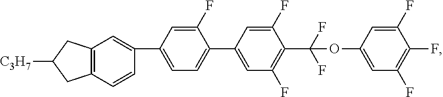
or the liquid crystal composition comprises:
a compound that accounts for 7% of the total weight of the liquid crystal composition: 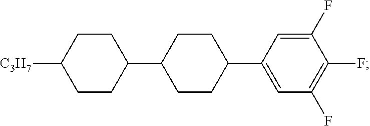
a compound that accounts for 10% of the total weight of the liquid crystal composition: 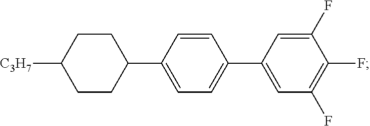
a compound that accounts for 4% of the total weight of the liquid crystal composition: 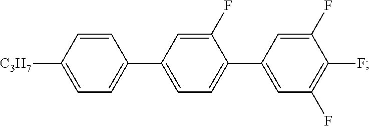
a compound that accounts for 4% of the total weight of the liquid crystal composition: 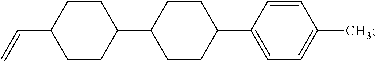 [SMILES: C=CC1CCC(C2CCC(c3ccc(C)cc3)CC2)CC1]
a compound that accounts for 45% of the total weight of the liquid crystal composition: 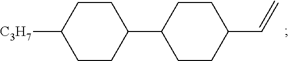
a compound that accounts for 6% of the total weight of the liquid crystal composition: 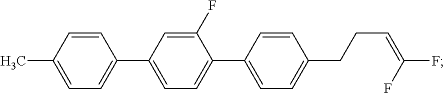 [SMILES: Cc1ccc(-c2ccc(-c3ccc(CCC=C(F)F)cc3)c(F)c2)cc1]
a compound that accounts for 6% of the total weight of the liquid crystal composition: 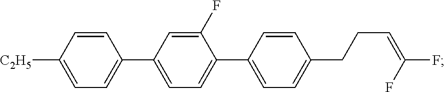 [SMILES: CCc1ccc(-c2ccc(-c3ccc(CCC=C(F)F)cc3)c(F)c2)cc1]
a compound that accounts for 5% of the total weight of the liquid crystal composition: 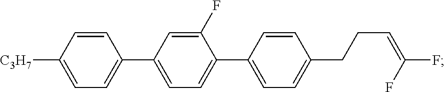
a compound that accounts for 4% of the total weight of the liquid crystal composition: 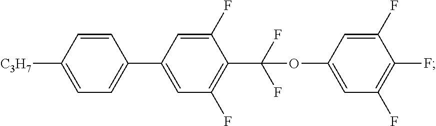
a compound that accounts for 4% of the total weight of the liquid crystal composition: 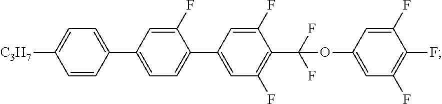
and
a compound that accounts for 5% of the total weight of the liquid crystal composition: 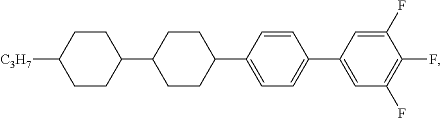
or the liquid crystal composition comprises:
a compound that accounts for 6% of the total weight of the liquid crystal composition: 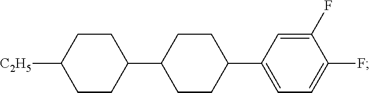 [SMILES: CCC1CCC(C2CCC(c3ccc(F)c(F)c3)CC2)CC1]
a compound that accounts for 9% of the total weight of the liquid crystal composition: 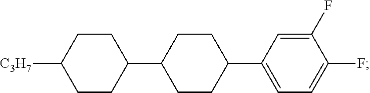
a compound that accounts for 4% of the total weight of the liquid crystal composition: 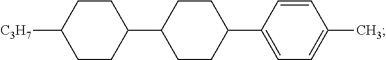
a compound that accounts for 5% of the total weight of the liquid crystal composition: 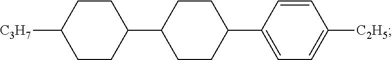
a compound that accounts for 3% of the total weight of the liquid crystal composition: 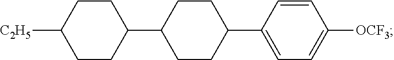 [SMILES: CCC1CCC(C2CCC(c3ccc(OC(F)(F)F)cc3)CC2)CC1]
a compound that accounts for 3% of the total weight of the liquid crystal composition: 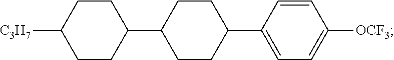
a compound that accounts for 30% of the total weight of the liquid crystal composition: 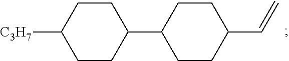
a compound that accounts for 8% of the total weight of the liquid crystal composition: 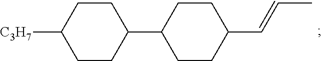
a compound that accounts for 3% of the total weight of the liquid crystal composition: 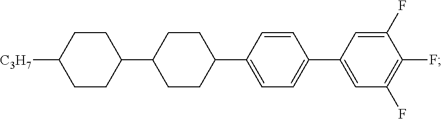
a compound that accounts for 7% of the total weight of the liquid crystal composition: 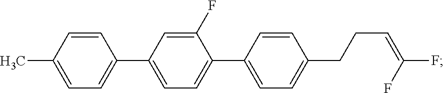 [SMILES: Cc1ccc(-c2ccc(-c3ccc(CCC=C(F)F)cc3)c(F)c2)cc1]
a compound that accounts for 5% of the total weight of the liquid crystal composition: 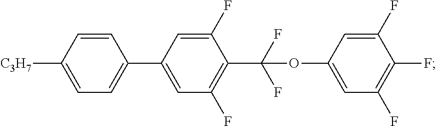
a compound that accounts for 10% of the total weight of the liquid crystal composition: 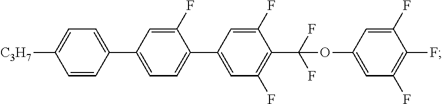
and
a compound that accounts for 7% of the total weight of the liquid crystal composition: 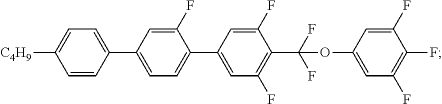
or the liquid crystal composition comprises:
a compound that accounts for 5% of the total weight of the liquid crystal composition: 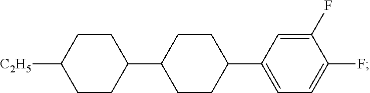 [SMILES: CCC1CCC(C2CCC(c3ccc(F)c(F)c3)CC2)CC1]
a compound that accounts for 8% of the total weight of the liquid crystal composition: 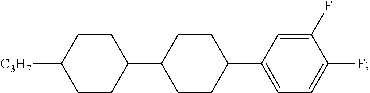
a compound that accounts for 6% of the total weight of the liquid crystal composition: 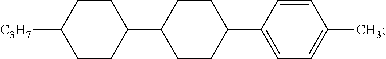
a compound that accounts for 4% of the total weight of the liquid crystal composition: 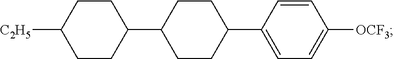 [SMILES: CCC1CCC(C2CCC(c3ccc(OC(F)(F)F)cc3)CC2)CC1]
a compound that accounts for 4% of the total weight of the liquid crystal composition: 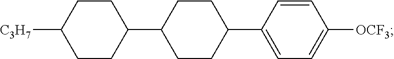
a compound that accounts for 30% of the total weight of the liquid crystal composition: 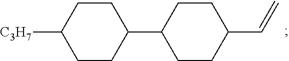
a compound that accounts for 10% of the total weight of the liquid crystal composition: 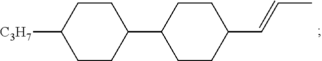
a compound that accounts for 3% of the total weight of the liquid crystal composition: 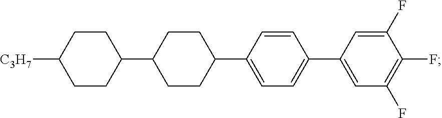
a compound that accounts for 8% of the total weight of the liquid crystal composition: 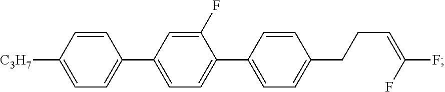
a compound that accounts for 5% of the total weight of the liquid crystal composition: 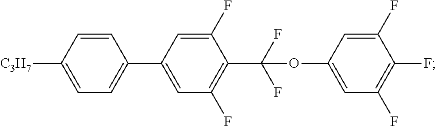
a compound that accounts for 10% of the total weight of the liquid crystal composition: 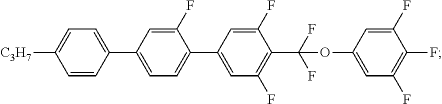
and
a compound that accounts for 7% of the total weight of the liquid crystal composition: 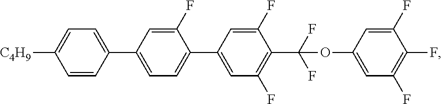
or the liquid crystal composition comprises:
a compound that accounts for 6% of the total weight of the liquid crystal composition: 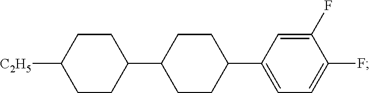 [SMILES: CCC1CCC(C2CCC(c3ccc(F)c(F)c3)CC2)CC1]
a compound that accounts for 8% of the total weight of the liquid crystal composition: 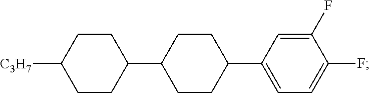
a compound that accounts for 7% of the total weight of the liquid crystal composition: 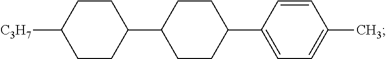
a compound that accounts for 5% of the total weight of the liquid crystal composition: 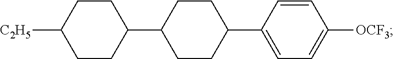 [SMILES: CCC1CCC(C2CCC(c3ccc(OC(F)(F)F)cc3)CC2)CC1]
a compound that accounts for 5% of the total weight of the liquid crystal composition: 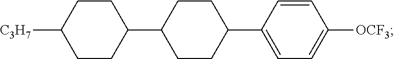
a compound that accounts for 30% of the total weight of the liquid crystal composition: 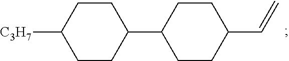
a compound that accounts for 10% of the total weight of the liquid crystal composition: 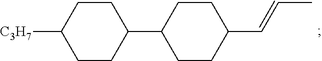
a compound that accounts for 3% of the total weight of the liquid crystal composition: 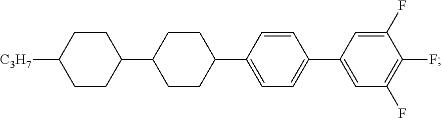
a compound that accounts for 4% of the total weight of the liquid crystal composition: 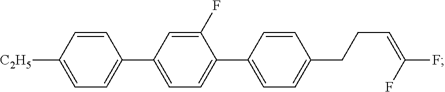 [SMILES: CCc1ccc(-c2ccc(-c3ccc(CCC=C(F)F)cc3)c(F)c2)cc1]
a compound that accounts for 5% of the total weight of the liquid crystal composition: 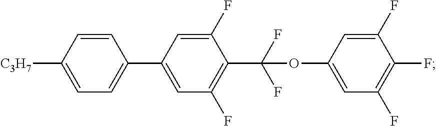
a compound that accounts for 10% of the total weight of the liquid crystal composition: 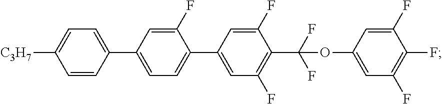
and
a compound that accounts for 7% of the total weight of the liquid crystal composition:

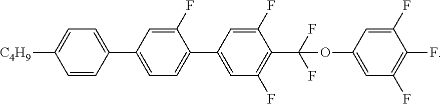

15. The liquid crystal composition according to claim 11, wherein the liquid crystal composition comprises:
a compound that accounts for 5% of the total weight of the liquid crystal composition: 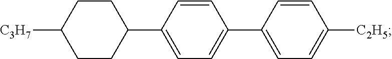
a compound that accounts for 2% of the total weight of the liquid crystal composition: 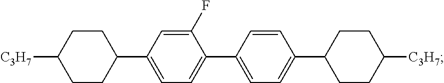
a compound that accounts for 2% of the total weight of the liquid crystal composition: 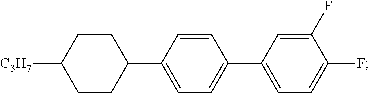
a compound that accounts for 52% of the total weight of the liquid crystal composition: 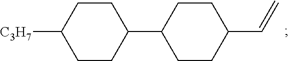
a compound that accounts for 3% of the total weight of the liquid crystal composition: 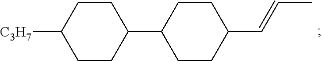
a compound that accounts for 6% of the total weight of the liquid crystal composition: 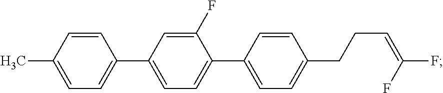 [SMILES: Cc1ccc(-c2ccc(-c3ccc(CCC=C(F)F)cc3)c(F)c2)cc1]
a compound that accounts for 6% of the total weight of the liquid crystal composition: 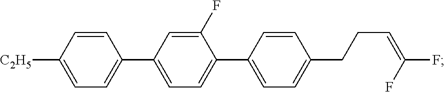 [SMILES: CCc1ccc(-c2ccc(-c3ccc(CCC=C(F)F)cc3)c(F)c2)cc1]
a compound that accounts for 6% of the total weight of the liquid crystal composition: 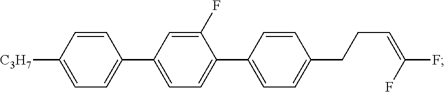
a compound that accounts for 4% of the total weight of the liquid crystal composition: 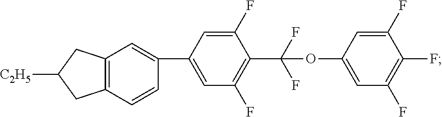 [SMILES: CCC1Cc2ccc(-c3cc(F)c(C(F)(F)Oc4cc(F)c(F)c(F)c4)c(F)c3)cc2C1]
a compound that accounts for 7% of the total weight of the liquid crystal composition: 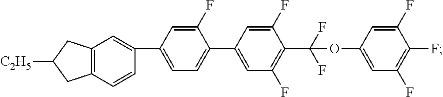 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 7% of the total weight of the liquid crystal composition: 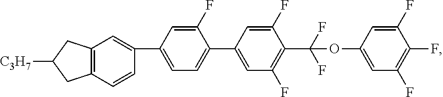
or the liquid crystal composition comprises:
a compound that accounts for 2% of the total weight of the liquid crystal composition: 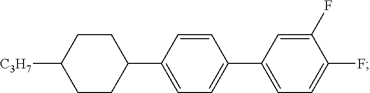
a compound that accounts for 6% of the total weight of the liquid crystal composition: 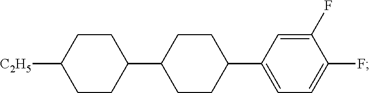 [SMILES: CCC1CCC(C2CCC(c3ccc(F)c(F)c3)CC2)CC1]
a compound that accounts for 6% of the total weight of the liquid crystal composition: 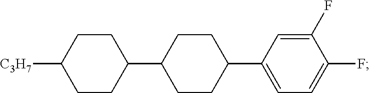
a compound that accounts for 6% of the total weight of the liquid crystal composition: 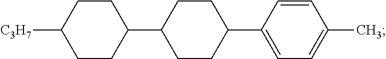
a compound that accounts for 4% of the total weight of the liquid crystal composition: 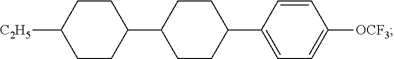 [SMILES: CCC1CCC(C2CCC(c3ccc(OC(F)(F)F)cc3)CC2)CC1]
a compound that accounts for 2% of the total weight of the liquid crystal composition: 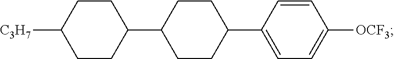
a compound that accounts for 34% of the total weight of the liquid crystal composition: 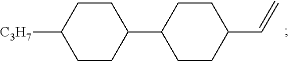
a compound that accounts for 11% of the total weight of the liquid crystal composition: 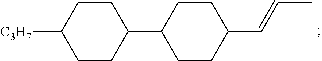
a compound that accounts for 7% of the total weight of the liquid crystal composition: 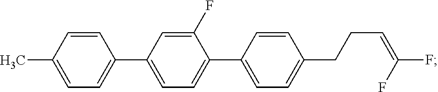 [SMILES: Cc1ccc(-c2ccc(-c3ccc(CCC=C(F)F)cc3)c(F)c2)cc1]
a compound that accounts for 4% of the total weight of the liquid crystal composition: 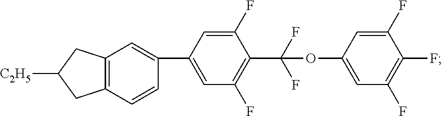 [SMILES: CCC1Cc2ccc(-c3cc(F)c(C(F)(F)Oc4cc(F)c(F)c(F)c4)c(F)c3)cc2C1]
a compound that accounts for 5% of the total weight of the liquid crystal composition: 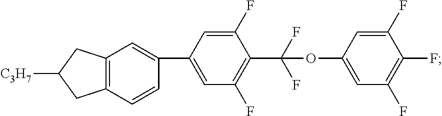
a compound that accounts for 6% of the total weight of the liquid crystal composition: 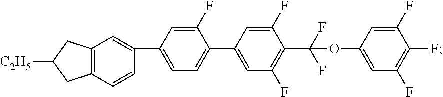 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 7% of the total weight of the liquid crystal composition: 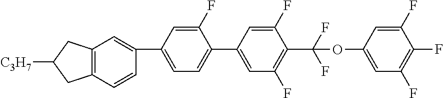
or the liquid crystal composition comprises:
a compound that accounts for 3% of the total weight of the liquid crystal composition: 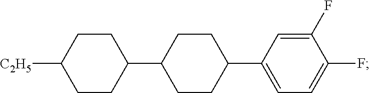 [SMILES: CCC1CCC(C2CCC(c3ccc(F)c(F)c3)CC2)CC1]
a compound that accounts for 4% of the total weight of the liquid crystal composition: 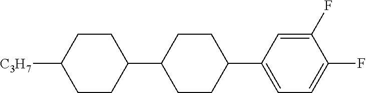
a compound that accounts for 4% of the total weight of the liquid crystal composition: 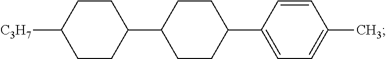
a compound that accounts for 4% of the total weight of the liquid crystal composition: 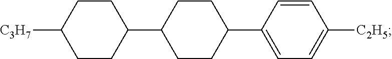
a compound that accounts for 4% of the total weight of the liquid crystal composition: 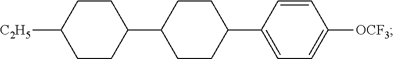 [SMILES: CCC1CCC(C2CCC(c3ccc(OC(F)(F)F)cc3)CC2)CC1]
a compound that accounts for 2% of the total weight of the liquid crystal composition: 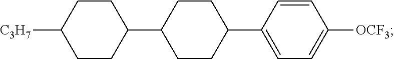
a compound that accounts for 34% of the total weight of the liquid crystal composition: 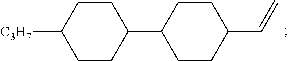
a compound that accounts for 11% of the total weight of the liquid crystal composition: 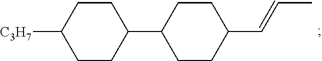
a compound that accounts for 6% of the total weight of the liquid crystal composition: 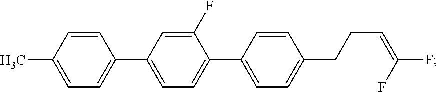 [SMILES: Cc1ccc(-c2ccc(-c3ccc(CCC=C(F)F)cc3)c(F)c2)cc1]
a compound that accounts for 6% of the total weight of the liquid crystal composition: 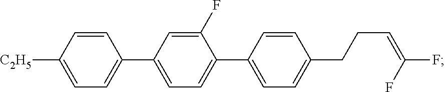 [SMILES: CCc1ccc(-c2ccc(-c3ccc(CCC=C(F)F)cc3)c(F)c2)cc1]
a compound that accounts for 4% of the total weight of the liquid crystal composition: 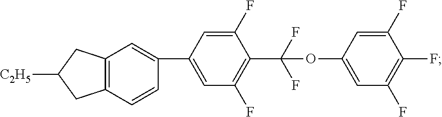 [SMILES: CCC1Cc2ccc(-c3cc(F)c(C(F)(F)Oc4cc(F)c(F)c(F)c4)c(F)c3)cc2C1]
a compound that accounts for 5% of the total weight of the liquid crystal composition: 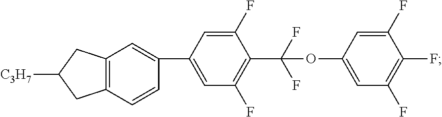
a compound that accounts for 7% of the total weight of the liquid crystal composition: 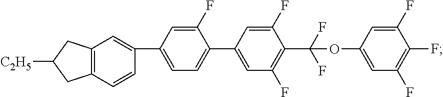 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 6% of the total weight of the liquid crystal composition: 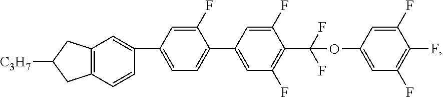
or the liquid crystal composition comprises:
a compound that accounts for 7% of the total weight of the liquid crystal composition: 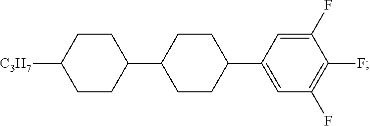
a compound that accounts for 10% of the total weight of the liquid crystal composition: 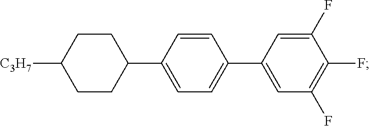
a compound that accounts for 4% of the total weight of the liquid crystal composition: 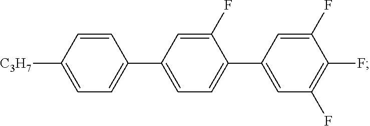
a compound that accounts for 4% of the total weight of the liquid crystal composition: 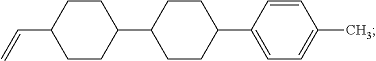 [SMILES: C=CC1CCC(C2CCC(c3ccc(C)cc3)CC2)CC1]
a compound that accounts for 45% of the total weight of the liquid crystal composition: 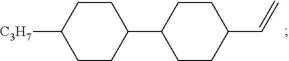
a compound that accounts for 6% of the total weight of the liquid crystal composition: 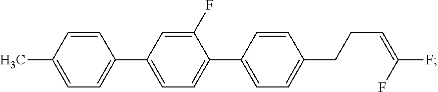 [SMILES: Cc1ccc(-c2ccc(-c3ccc(CCC=C(F)F)cc3)c(F)c2)cc1]
a compound that accounts for 6% of the total weight of the liquid crystal composition: 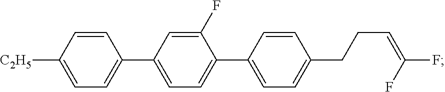 [SMILES: CCc1ccc(-c2ccc(-c3ccc(CCC=C(F)F)cc3)c(F)c2)cc1]
a compound that accounts for 5% of the total weight of the liquid crystal composition: 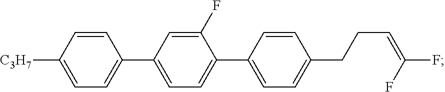
a compound that accounts for 4% of the total weight of the liquid crystal composition: 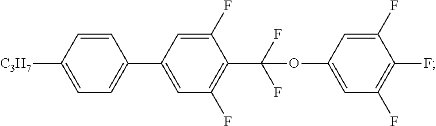
a compound that accounts for 4% of the total weight of the liquid crystal composition: 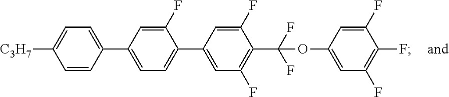
a compound that accounts for 5% of the total weight of the liquid crystal composition: 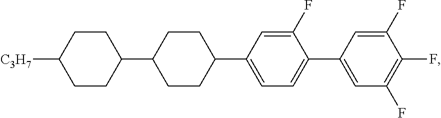
or the liquid crystal composition comprises:
a compound that accounts for 6% of the total weight of the liquid crystal composition: 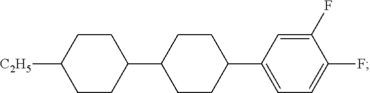 [SMILES: CCC1CCC(C2CCC(c3ccc(F)c(F)c3)CC2)CC1]
a compound that accounts for 9% of the total weight of the liquid crystal composition: 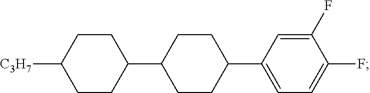
a compound that accounts for 4% of the total weight of the liquid crystal composition: 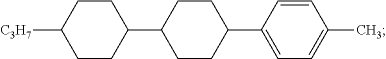
a compound that accounts for 5% of the total weight of the liquid crystal composition: 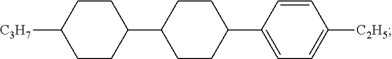
a compound that accounts for 3% of the total weight of the liquid crystal composition: 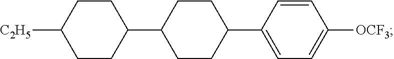 [SMILES: CCC1CCC(C2CCC(c3ccc(OC(F)(F)F)cc3)CC2)CC1]
a compound that accounts for 3% of the total weight of the liquid crystal composition: 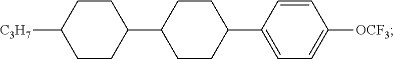
a compound that accounts for 30% of the total weight of the liquid crystal composition: 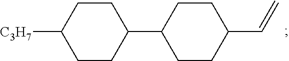
a compound that accounts for 8% of the total weight of the liquid crystal composition: 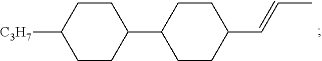
a compound that accounts for 3% of the total weight of the liquid crystal composition: 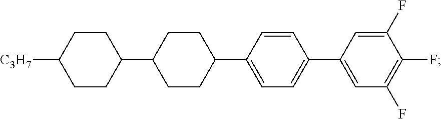
a compound that accounts for 7% of the total weight of the liquid crystal composition: 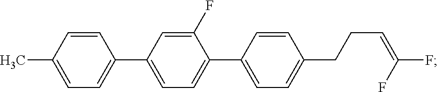 [SMILES: Cc1ccc(-c2ccc(-c3ccc(CCC=C(F)F)cc3)c(F)c2)cc1]
a compound that accounts for 5% of the total weight of the liquid crystal composition: 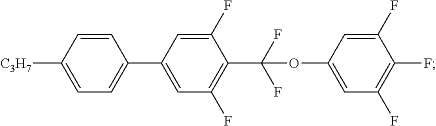
a compound that accounts for 10% of the total weight of the liquid crystal composition: 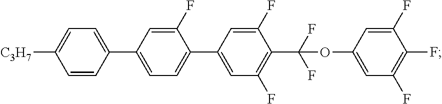
and
a compound that accounts for 7% of the total weight of the liquid crystal composition: 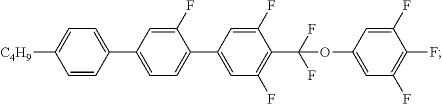
or the liquid crystal composition comprises:
a compound that accounts for 5% of the total weight of the liquid crystal composition: 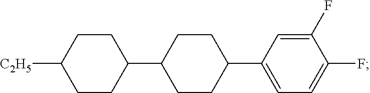 [SMILES: CCC1CCC(C2CCC(c3ccc(F)c(F)c3)CC2)CC1]
a compound that accounts for 8% of the total weight of the liquid crystal composition: 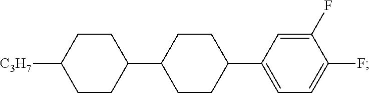
a compound that accounts for 6% of the total weight of the liquid crystal composition: 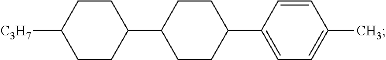
a compound that accounts for 4% of the total weight of the liquid crystal composition: 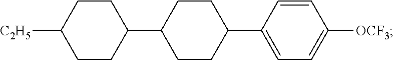 [SMILES: CCC1CCC(C2CCC(c3ccc(OC(F)(F)F)cc3)CC2)CC1]
a compound that accounts for 4% of the total weight of the liquid crystal composition: 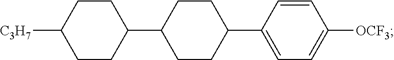
a compound that accounts for 30% of the total weight of the liquid crystal composition: 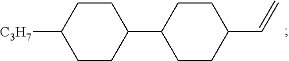
a compound that accounts for 10% of the total weight of the liquid crystal composition: 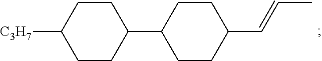
a compound that accounts for 3% of the total weight of the liquid crystal composition: 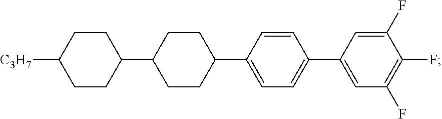
a compound that accounts for 8% of the total weight of the liquid crystal composition: 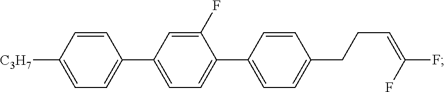
a compound that accounts for 5% of the total weight of the liquid crystal composition: 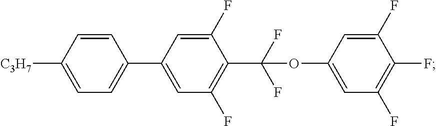
a compound that accounts for 10% of the total weight of the liquid crystal composition: 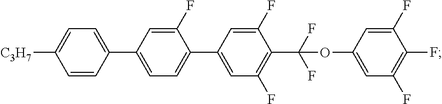
and
a compound that accounts for 7% of the total weight of the liquid crystal composition: 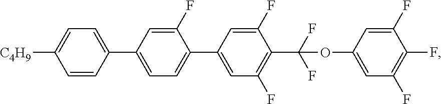
or the liquid crystal composition comprises:
a compound that accounts for 6% of the total weight of the liquid crystal composition: 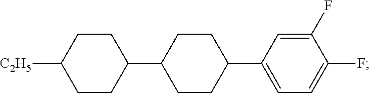 [SMILES: CCC1CCC(C2CCC(c3ccc(F)c(F)c3)CC2)CC1]
a compound that accounts for 8% of the total weight of the liquid crystal composition: 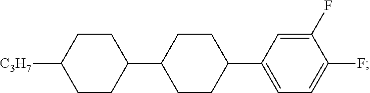
a compound that accounts for 7% of the total weight of the liquid crystal composition: 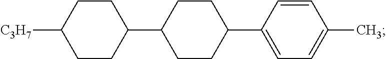
a compound that accounts for 5% of the total weight of the liquid crystal composition: 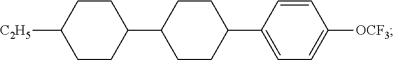 [SMILES: CCC1CCC(C2CCC(c3ccc(OC(F)(F)F)cc3)CC2)CC1]
a compound that accounts for 5% of the total weight of the liquid crystal composition: 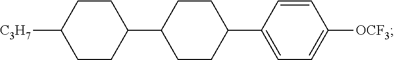
a compound that accounts for 30% of the total weight of the liquid crystal composition: 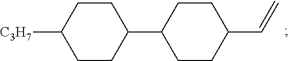
a compound that accounts for 10% of the total weight of the liquid crystal composition: 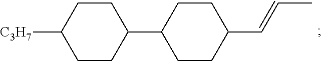
a compound that accounts for 3% of the total weight of the liquid crystal composition: 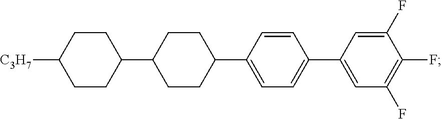
a compound that accounts for 4% of the total weight of the liquid crystal composition: 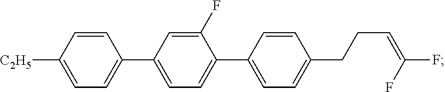 [SMILES: CCc1ccc(-c2ccc(-c3ccc(CCC=C(F)F)cc3)c(F)c2)cc1]
a compound that accounts for 5% of the total weight of the liquid crystal composition: 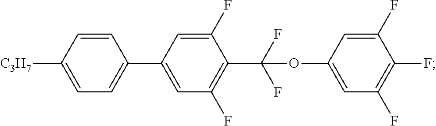
a compound that accounts for 10% of the total weight of the liquid crystal composition: 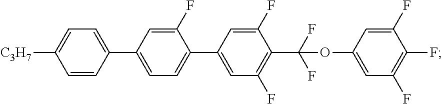
and
a compound that accounts for 7% of the total weight of the liquid crystal composition:

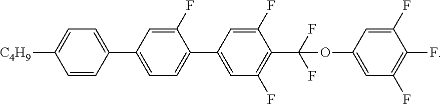

16. The liquid crystal composition according to claim 12, wherein the liquid crystal composition comprises:
a compound that accounts for 5% of the total weight of the liquid crystal composition: 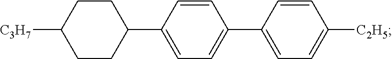
a compound that accounts for 2% of the total weight of the liquid crystal composition: 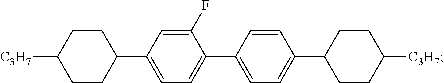
a compound that accounts for 2% of the total weight of the liquid crystal composition: 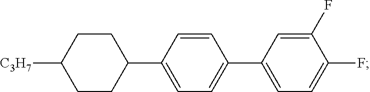
a compound that accounts for 52% of the total weight of the liquid crystal composition: 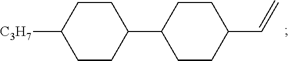
a compound that accounts for 3% of the total weight of the liquid crystal composition: 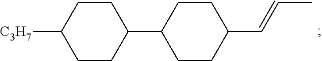
a compound that accounts for 6% of the total weight of the liquid crystal composition: 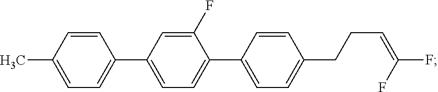 [SMILES: Cc1ccc(-c2ccc(-c3ccc(CCC=C(F)F)cc3)c(F)c2)cc1]
a compound that accounts for 6% of the total weight of the liquid crystal composition: 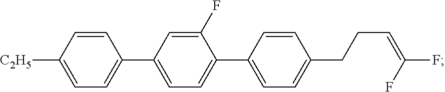 [SMILES: CCc1ccc(-c2ccc(-c3ccc(CCC=C(F)F)cc3)c(F)c2)cc1]
a compound that accounts for 6% of the total weight of the liquid crystal composition: 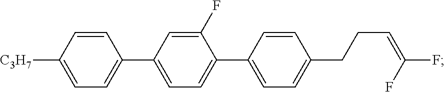
a compound that accounts for 4% of the total weight of the liquid crystal composition: 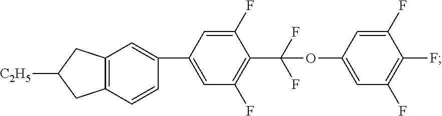 [SMILES: CCC1Cc2ccc(-c3cc(F)c(C(F)(F)Oc4cc(F)c(F)c(F)c4)c(F)c3)cc2C1]
a compound that accounts for 7% of the total weight of the liquid crystal composition: 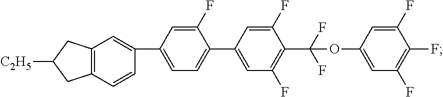 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 7% of the total weight of the liquid crystal composition: 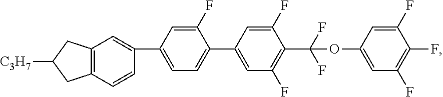
or the liquid crystal composition comprises:
a compound that accounts for 2% of the total weight of the liquid crystal composition: 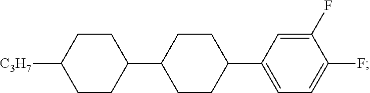
a compound that accounts for 6% of the total weight of the liquid crystal composition: 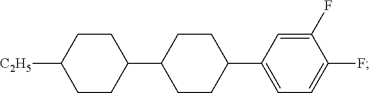 [SMILES: CCC1CCC(C2CCC(c3ccc(F)c(F)c3)CC2)CC1]
a compound that accounts for 6% of the total weight of the liquid crystal composition: 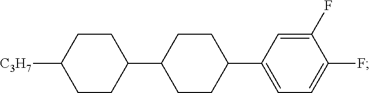
a compound that accounts for 6% of the total weight of the liquid crystal composition: 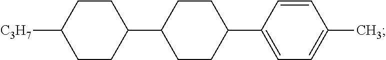
a compound that accounts for 4% of the total weight of the liquid crystal composition: 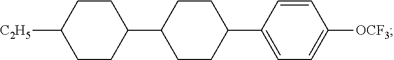 [SMILES: CCC1CCC(C2CCC(c3ccc(OC(F)(F)F)cc3)CC2)CC1]
a compound that accounts for 2% of the total weight of the liquid crystal composition: 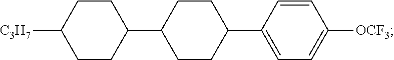
a compound that accounts for 34% of the total weight of the liquid crystal composition: 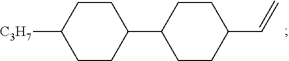
a compound that accounts for 11% of the total weight of the liquid crystal composition: 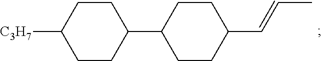
a compound that accounts for 7% of the total weight of the liquid crystal composition: 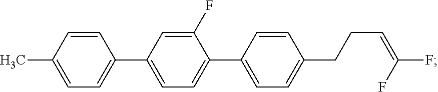 [SMILES: Cc1ccc(-c2ccc(-c3ccc(CCC=C(F)F)cc3)c(F)c2)cc1]
a compound that accounts for 4% of the total weight of the liquid crystal composition: 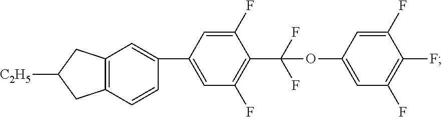 [SMILES: CCC1Cc2ccc(-c3cc(F)c(C(F)(F)Oc4cc(F)c(F)c(F)c4)c(F)c3)cc2C1]
a compound that accounts for 5% of the total weight of the liquid crystal composition: 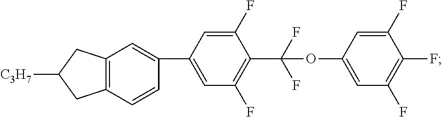
a compound that accounts for 6% of the total weight of the liquid crystal composition: 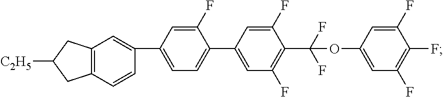 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 7% of the total weight of the liquid crystal composition: 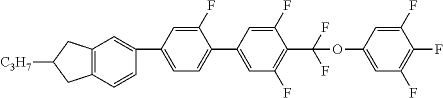
or the liquid crystal composition comprises:
a compound that accounts for 3% of the total weight of the liquid crystal composition: 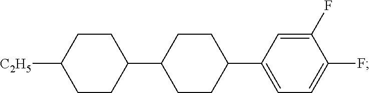 [SMILES: CCC1CCC(C2CCC(c3ccc(F)c(F)c3)CC2)CC1]
a compound that accounts for 4% of the total weight of the liquid crystal composition: 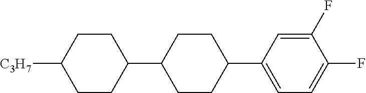
a compound that accounts for 4% of the total weight of the liquid crystal composition: 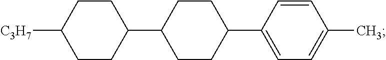
a compound that accounts for 4% of the total weight of the liquid crystal composition: 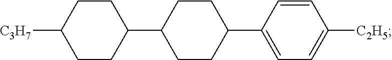
a compound that accounts for 4% of the total weight of the liquid crystal composition: 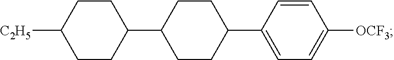 [SMILES: CCC1CCC(C2CCC(c3ccc(OC(F)(F)F)cc3)CC2)CC1]
a compound that accounts for 2% of the total weight of the liquid crystal composition: 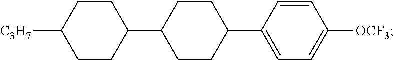
a compound that accounts for 34% of the total weight of the liquid crystal composition: 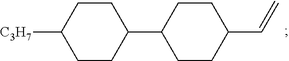
a compound that accounts for 11% of the total weight of the liquid crystal composition: 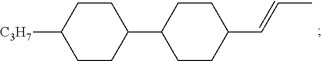
a compound that accounts for 6% of the total weight of the liquid crystal composition: 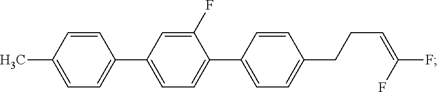 [SMILES: Cc1ccc(-c2ccc(-c3ccc(CCC=C(F)F)cc3)c(F)c2)cc1]
a compound that accounts for 6% of the total weight of the liquid crystal composition: 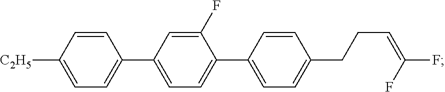 [SMILES: CCc1ccc(-c2ccc(-c3ccc(CCC=C(F)F)cc3)c(F)c2)cc1]
a compound that accounts for 4% of the total weight of the liquid crystal composition: 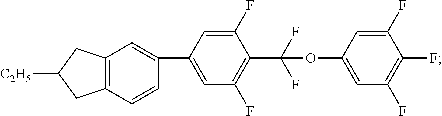 [SMILES: CCC1Cc2ccc(-c3cc(F)c(C(F)(F)Oc4cc(F)c(F)c(F)c4)c(F)c3)cc2C1]
a compound that accounts for 5% of the total weight of the liquid crystal composition: 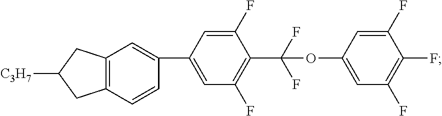
a compound that accounts for 7% of the total weight of the liquid crystal composition: 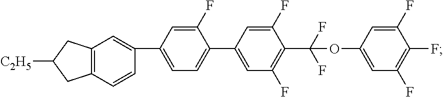 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 6% of the total weight of the liquid crystal composition: 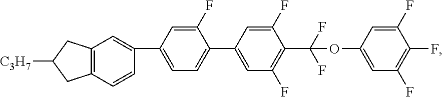
or the liquid crystal composition comprises:
a compound that accounts for 7% of the total weight of the liquid crystal composition: 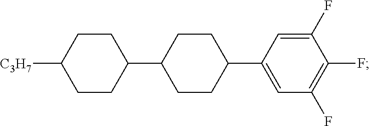
a compound that accounts for 10% of the total weight of the liquid crystal composition: 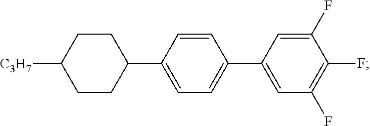
a compound that accounts for 4% of the total weight of the liquid crystal composition: 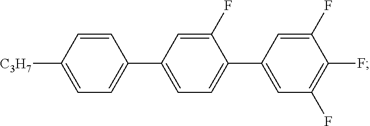
a compound that accounts for 4% of the total weight of the liquid crystal composition: 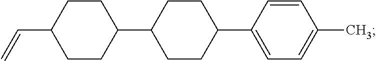 [SMILES: C=CC1CCC(C2CCC(c3ccc(C)cc3)CC2)CC1]
a compound that accounts for 45% of the total weight of the liquid crystal composition: 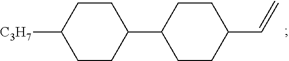
a compound that accounts for 6% of the total weight of the liquid crystal composition: 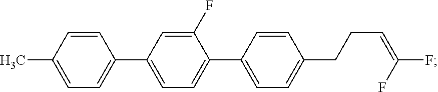 [SMILES: Cc1ccc(-c2ccc(-c3ccc(CCC=C(F)F)cc3)c(F)c2)cc1]
a compound that accounts for 6% of the total weight of the liquid crystal composition: 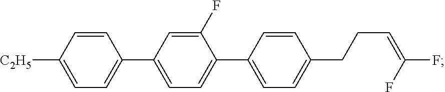 [SMILES: CCc1ccc(-c2ccc(-c3ccc(CCC=C(F)F)cc3)c(F)c2)cc1]
a compound that accounts for 5% of the total weight of the liquid crystal composition: 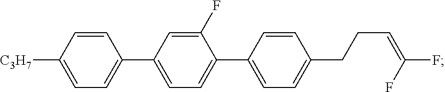
a compound that accounts for 4% of the total weight of the liquid crystal composition: 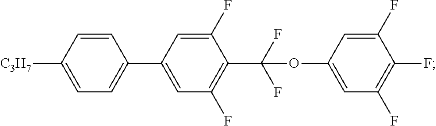
a compound that accounts for 4% of the total weight of the liquid crystal composition: 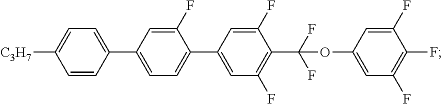
and
a compound that accounts for 5% of the total weight of the liquid crystal composition: 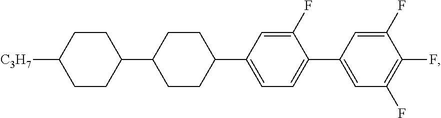
or the liquid crystal composition comprises:
a compound that accounts for 6% of the total weight of the liquid crystal composition: 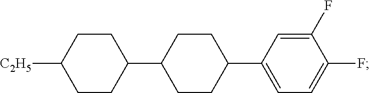 [SMILES: CCC1CCC(C2CCC(c3ccc(F)c(F)c3)CC2)CC1]
a compound that accounts for 9% of the total weight of the liquid crystal composition: 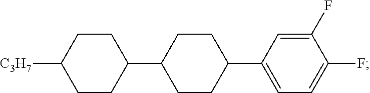
a compound that accounts for 4% of the total weight of the liquid crystal composition: 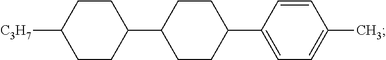
a compound that accounts for 5% of the total weight of the liquid crystal composition: 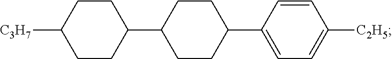
a compound that accounts for 3% of the total weight of the liquid crystal composition: 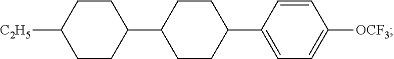 [SMILES: CCC1CCC(C2CCC(c3ccc(OC(F)(F)F)cc3)CC2)CC1]
a compound that accounts for 3% of the total weight of the liquid crystal composition: 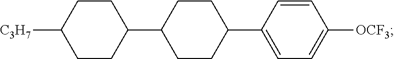
a compound that accounts for 30% of the total weight of the liquid crystal composition: 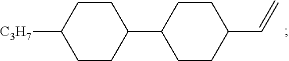
a compound that accounts for 8% of the total weight of the liquid crystal composition: 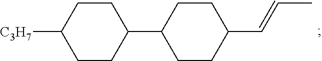
a compound that accounts for 3% of the total weight of the liquid crystal composition: 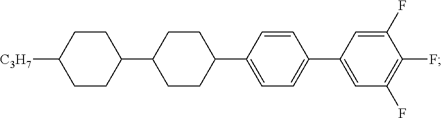
a compound that accounts for 7% of the total weight of the liquid crystal composition: 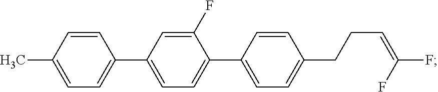 [SMILES: Cc1ccc(-c2ccc(-c3ccc(CCC=C(F)F)cc3)c(F)c2)cc1]
a compound that accounts for 5% of the total weight of the liquid crystal composition: 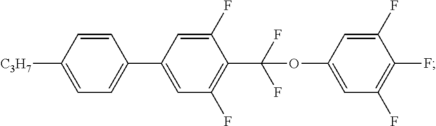
a compound that accounts for 10% of the total weight of the liquid crystal composition: 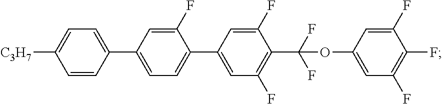
and
a compound that accounts for 7% of the total weight of the liquid crystal composition: 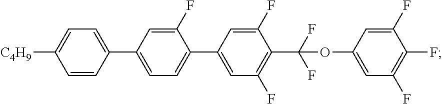
or the liquid crystal composition comprises:
a compound that accounts for 5% of the total weight of the liquid crystal composition: 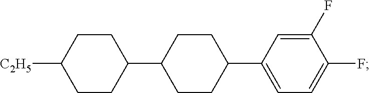 [SMILES: CCC1CCC(C2CCC(c3ccc(F)c(F)c3)CC2)CC1]
a compound that accounts for 8% of the total weight of the liquid crystal composition: 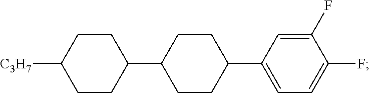
a compound that accounts for 6% of the total weight of the liquid crystal composition: 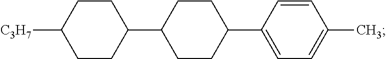
a compound that accounts for 4% of the total weight of the liquid crystal composition: 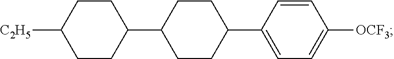 [SMILES: CCC1CCC(C2CCC(c3ccc(OC(F)(F)F)cc3)CC2)CC1]
a compound that accounts for 4% of the total weight of the liquid crystal composition: 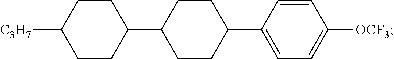
a compound that accounts for 30% of the total weight of the liquid crystal composition: 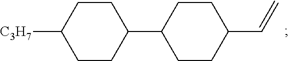
a compound that accounts for 10% of the total weight of the liquid crystal composition: 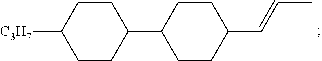
a compound that accounts for 3% of the total weight of the liquid crystal composition: 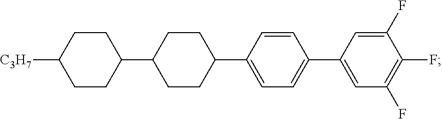
a compound that accounts for 8% of the total weight of the liquid crystal composition: 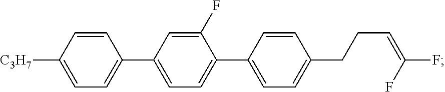
a compound that accounts for 5% of the total weight of the liquid crystal composition: 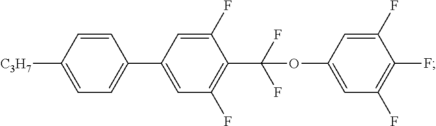
a compound that accounts for 10% of the total weight of the liquid crystal composition: 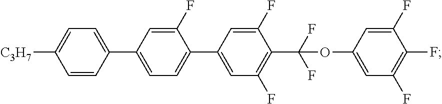
and
a compound that accounts for 7% of the total weight of the liquid crystal composition: 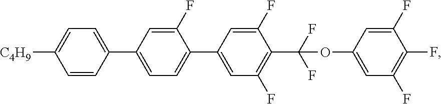
or the liquid crystal composition comprises:
a compound that accounts for 6% of the total weight of the liquid crystal composition: 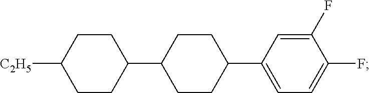 [SMILES: CCC1CCC(C2CCC(c3ccc(F)c(F)c3)CC2)CC1]
a compound that accounts for 8% of the total weight of the liquid crystal composition: 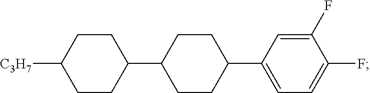
a compound that accounts for 7% of the total weight of the liquid crystal composition: 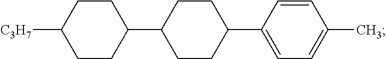
a compound that accounts for 5% of the total weight of the liquid crystal composition: 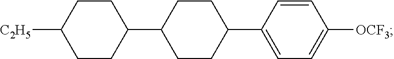 [SMILES: CCC1CCC(C2CCC(c3ccc(OC(F)(F)F)cc3)CC2)CC1]
a compound that accounts for 5% of the total weight of the liquid crystal composition: 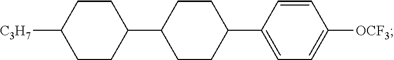
a compound that accounts for 30% of the total weight of the liquid crystal composition: 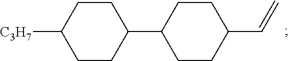
a compound that accounts for 10% of the total weight of the liquid crystal composition: 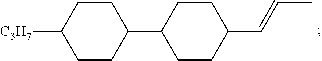
a compound that accounts for 3% of the total weight of the liquid crystal composition: 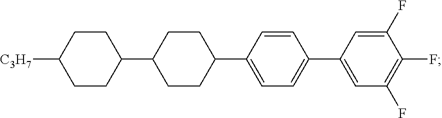
a compound that accounts for 4% of the total weight of the liquid crystal composition: 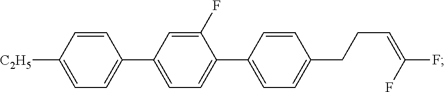 [SMILES: CCc1ccc(-c2ccc(-c3ccc(CCC=C(F)F)cc3)c(F)c2)cc1]
a compound that accounts for 5% of the total weight of the liquid crystal composition: 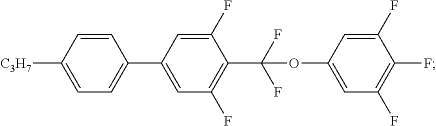
a compound that accounts for 10% of the total weight of the liquid crystal composition: 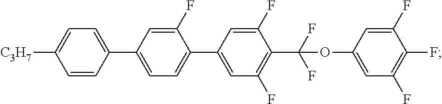
and
a compound that accounts for 7% of the total weight of the liquid crystal composition:

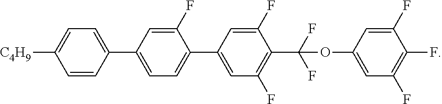

17. The liquid crystal composition according to claim 13, wherein the liquid crystal composition comprises:
a compound that accounts for 5% of the total weight of the liquid crystal composition: 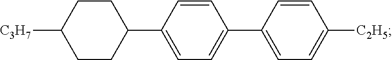
a compound that accounts for 2% of the total weight of the liquid crystal composition: 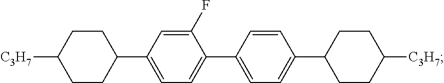
a compound that accounts for 2% of the total weight of the liquid crystal composition: 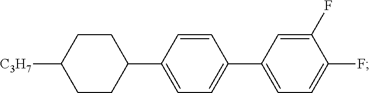
a compound that accounts for 52% of the total weight of the liquid crystal composition: 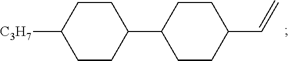
a compound that accounts for 3% of the total weight of the liquid crystal composition: 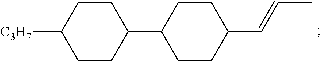
a compound that accounts for 6% of the total weight of the liquid crystal composition: 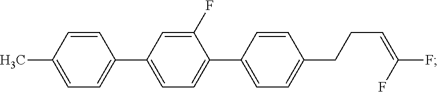 [SMILES: Cc1ccc(-c2ccc(-c3ccc(CCC=C(F)F)cc3)c(F)c2)cc1]
a compound that accounts for 6% of the total weight of the liquid crystal composition: 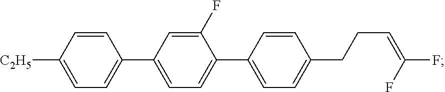 [SMILES: CCc1ccc(-c2ccc(-c3ccc(CCC=C(F)F)cc3)c(F)c2)cc1]
a compound that accounts for 6% of the total weight of the liquid crystal composition: 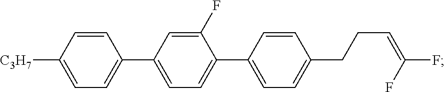
a compound that accounts for 4% of the total weight of the liquid crystal composition: 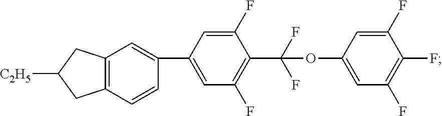 [SMILES: CCC1Cc2ccc(-c3cc(F)c(C(F)(F)Oc4cc(F)c(F)c(F)c4)c(F)c3)cc2C1]
a compound that accounts for 7% of the total weight of the liquid crystal composition: 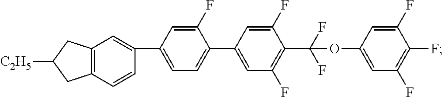 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 7% of the total weight of the liquid crystal composition: 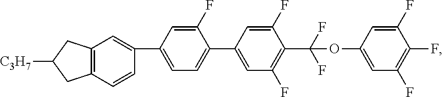
or the liquid crystal composition comprises:
a compound that accounts for 2% of the total weight of the liquid crystal composition: 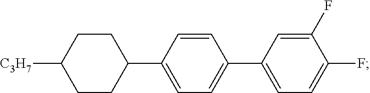
a compound that accounts for 6% of the total weight of the liquid crystal composition: 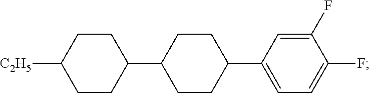 [SMILES: CCC1CCC(C2CCC(c3ccc(F)c(F)c3)CC2)CC1]
a compound that accounts for 6% of the total weight of the liquid crystal composition: 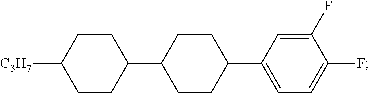
a compound that accounts for 6% of the total weight of the liquid crystal composition: 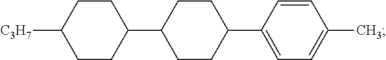
a compound that accounts for 4% of the total weight of the liquid crystal composition: 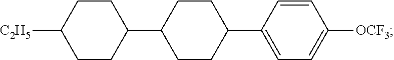 [SMILES: CCC1CCC(C2CCC(c3ccc(OC(F)(F)F)cc3)CC2)CC1]
a compound that accounts for 2% of the total weight of the liquid crystal composition: 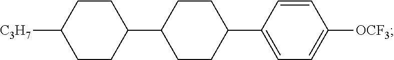
a compound that accounts for 34% of the total weight of the liquid crystal composition: 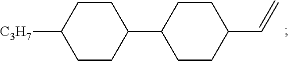
a compound that accounts for 11% of the total weight of the liquid crystal composition: 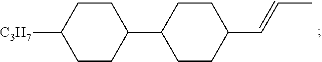
a compound that accounts for 7% of the total weight of the liquid crystal composition: 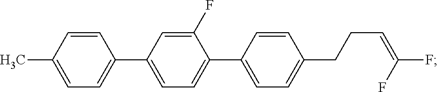 [SMILES: Cc1ccc(-c2ccc(-c3ccc(CCC=C(F)F)cc3)c(F)c2)cc1]
a compound that accounts for 4% of the total weight of the liquid crystal composition: 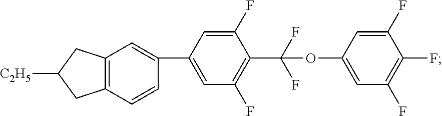 [SMILES: CCC1Cc2ccc(-c3cc(F)c(C(F)(F)Oc4cc(F)c(F)c(F)c4)c(F)c3)cc2C1]
a compound that accounts for 5% of the total weight of the liquid crystal composition: 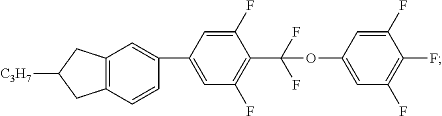
a compound that accounts for 6% of the total weight of the liquid crystal composition: 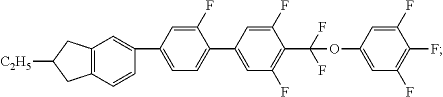 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 7% of the total weight of the liquid crystal composition: 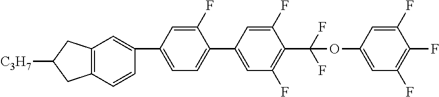
or the liquid crystal composition comprises:
a compound that accounts for 3% of the total weight of the liquid crystal composition: 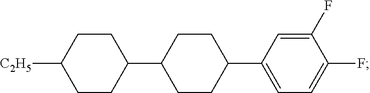 [SMILES: CCC1CCC(C2CCC(c3ccc(F)c(F)c3)CC2)CC1]
a compound that accounts for 4% of the total weight of the liquid crystal composition: 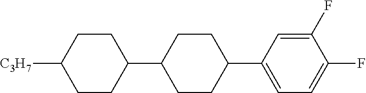
a compound that accounts for 4% of the total weight of the liquid crystal composition: 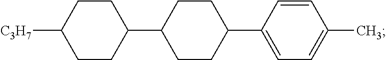
a compound that accounts for 4% of the total weight of the liquid crystal composition: 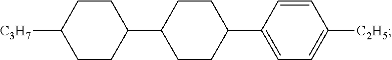
a compound that accounts for 4% of the total weight of the liquid crystal composition: 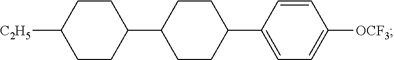 [SMILES: CCC1CCC(C2CCC(c3ccc(OC(F)(F)F)cc3)CC2)CC1]
a compound that accounts for 2% of the total weight of the liquid crystal composition: 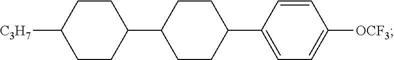
a compound that accounts for 34% of the total weight of the liquid crystal composition: 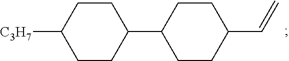
a compound that accounts for 11% of the total weight of the liquid crystal composition: 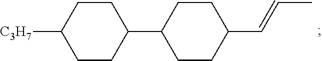
a compound that accounts for 6% of the total weight of the liquid crystal composition: 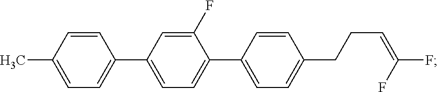 [SMILES: Cc1ccc(-c2ccc(-c3ccc(CCC=C(F)F)cc3)c(F)c2)cc1]
a compound that accounts for 6% of the total weight of the liquid crystal composition: 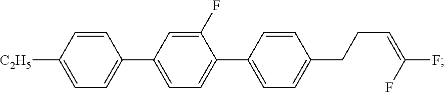 [SMILES: CCc1ccc(-c2ccc(-c3ccc(CCC=C(F)F)cc3)c(F)c2)cc1]
a compound that accounts for 4% of the total weight of the liquid crystal composition: 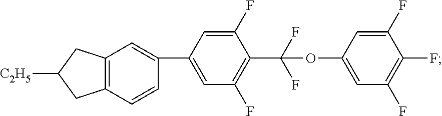 [SMILES: CCC1Cc2ccc(-c3cc(F)c(C(F)(F)Oc4cc(F)c(F)c(F)c4)c(F)c3)cc2C1]
a compound that accounts for 5% of the total weight of the liquid crystal composition: 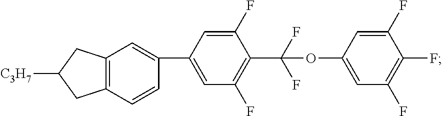
a compound that accounts for 7% of the total weight of the liquid crystal composition: 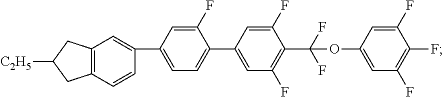 [SMILES: CCC1Cc2ccc(-c3ccc(-c4cc(F)c(C(F)(F)Oc5cc(F)c(F)c(F)c5)c(F)c4)c(F)c3)cc2C1]
and
a compound that accounts for 6% of the total weight of the liquid crystal composition: 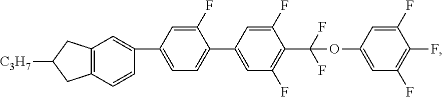
or the liquid crystal composition comprises:
a compound that accounts for 7% of the total weight of the liquid crystal composition: 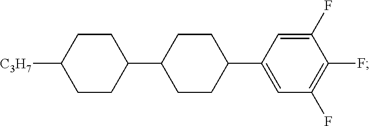
a compound that accounts for 10% of the total weight of the liquid crystal composition: 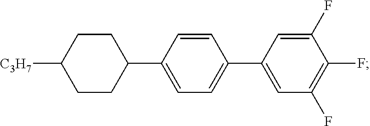
a compound that accounts for 4% of the total weight of the liquid crystal composition: 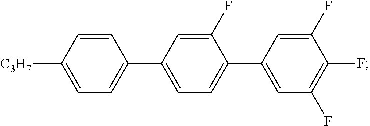
a compound that accounts for 4% of the total weight of the liquid crystal composition: 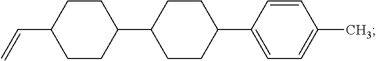 [SMILES: C=CC1CCC(C2CCC(c3ccc(C)cc3)CC2)CC1]
a compound that accounts for 45% of the total weight of the liquid crystal composition: 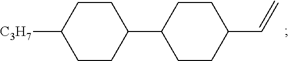
a compound that accounts for 6% of the total weight of the liquid crystal composition: 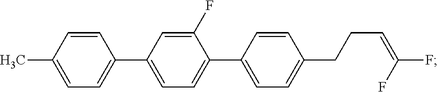 [SMILES: Cc1ccc(-c2ccc(-c3ccc(CCC=C(F)F)cc3)c(F)c2)cc1]
a compound that accounts for 6% of the total weight of the liquid crystal composition: 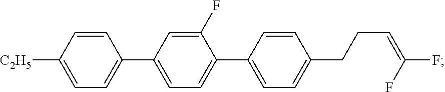 [SMILES: CCc1ccc(-c2ccc(-c3ccc(CCC=C(F)F)cc3)c(F)c2)cc1]
a compound that accounts for 5% of the total weight of the liquid crystal composition: 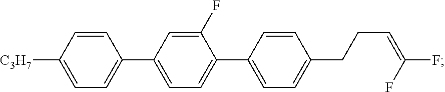
a compound that accounts for 4% of the total weight of the liquid crystal composition: 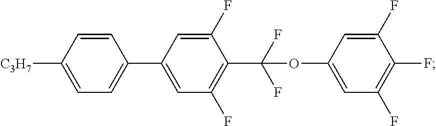
a compound that accounts for 4% of the total weight of the liquid crystal composition: 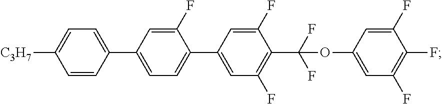
and
a compound that accounts for 5% of the total weight of the liquid crystal composition: 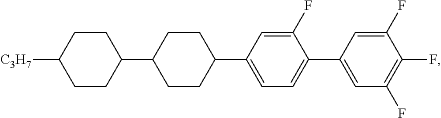
or the liquid crystal composition comprises:
a compound that accounts for 6% of the total weight of the liquid crystal composition: 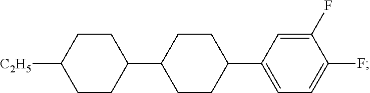 [SMILES: CCC1CCC(C2CCC(c3ccc(F)c(F)c3)CC2)CC1]
a compound that accounts for 9% of the total weight of the liquid crystal composition: 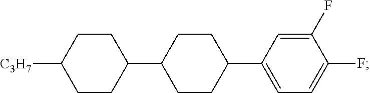
a compound that accounts for 4% of the total weight of the liquid crystal composition: 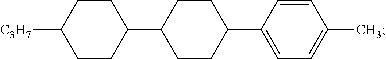
a compound that accounts for 5% of the total weight of the liquid crystal composition: 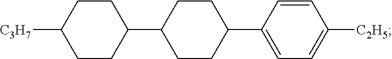
a compound that accounts for 3% of the total weight of the liquid crystal composition: 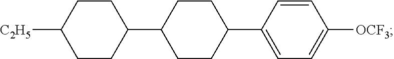 [SMILES: CCC1CCC(C2CCC(c3ccc(OC(F)(F)F)cc3)CC2)CC1]
a compound that accounts for 3% of the total weight of the liquid crystal composition: 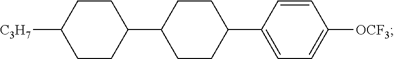
a compound that accounts for 30% of the total weight of the liquid crystal composition: 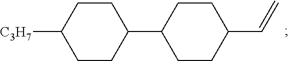
a compound that accounts for 8% of the total weight of the liquid crystal composition: 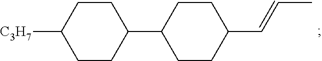
a compound that accounts for 3% of the total weight of the liquid crystal composition: 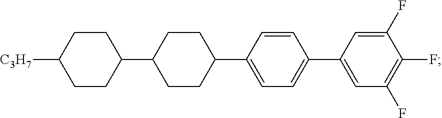
a compound that accounts for 7% of the total weight of the liquid crystal composition: 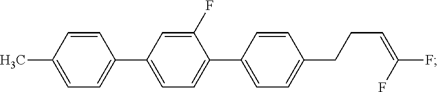 [SMILES: Cc1ccc(-c2ccc(-c3ccc(CCC=C(F)F)cc3)c(F)c2)cc1]
a compound that accounts for 5% of the total weight of the liquid crystal composition: 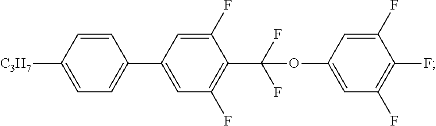
a compound that accounts for 10% of the total weight of the liquid crystal composition: 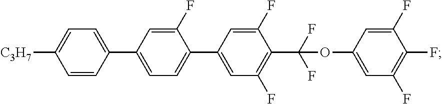
and
a compound that accounts for 7% of the total weight of the liquid crystal composition: 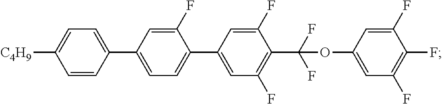
or the liquid crystal composition comprises:
a compound that accounts for 5% of the total weight of the liquid crystal composition: 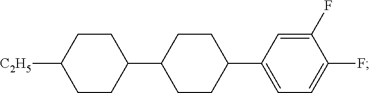 [SMILES: CCC1CCC(C2CCC(c3ccc(F)c(F)c3)CC2)CC1]
a compound that accounts for 8% of the total weight of the liquid crystal composition: 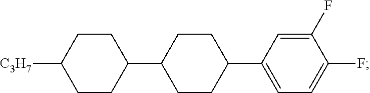
a compound that accounts for 6% of the total weight of the liquid crystal composition: 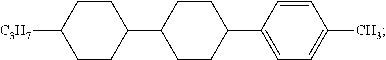
a compound that accounts for 4% of the total weight of the liquid crystal composition: 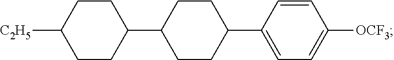 [SMILES: CCC1CCC(C2CCC(c3ccc(OC(F)(F)F)cc3)CC2)CC1]
a compound that accounts for 4% of the total weight of the liquid crystal composition: 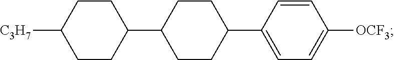
a compound that accounts for 30% of the total weight of the liquid crystal composition: 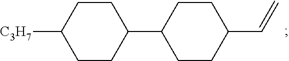
a compound that accounts for 10% of the total weight of the liquid crystal composition: 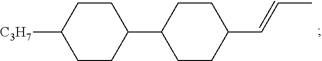
a compound that accounts for 3% of the total weight of the liquid crystal composition: 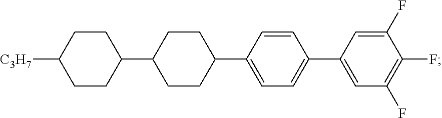
a compound that accounts for 8% of the total weight of the liquid crystal composition: 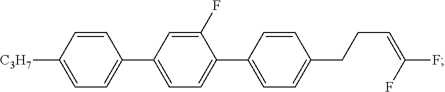
a compound that accounts for 5% of the total weight of the liquid crystal composition: 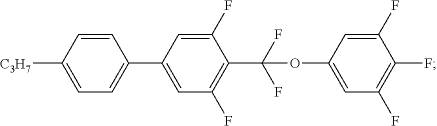
a compound that accounts for 10% of the total weight of the liquid crystal composition: 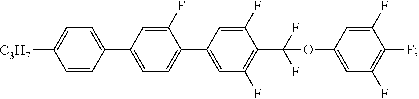
and
a compound that accounts for 7% of the total weight of the liquid crystal composition: 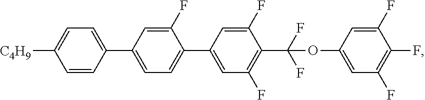
or the liquid crystal composition comprises:
a compound that accounts for 6% of the total weight of the liquid crystal composition: 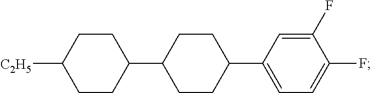 [SMILES: CCC1CCC(C2CCC(c3ccc(F)c(F)c3)CC2)CC1]
a compound that accounts for 8% of the total weight of the liquid crystal composition: 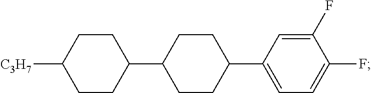
a compound that accounts for 7% of the total weight of the liquid crystal composition: 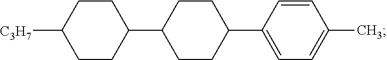
a compound that accounts for 5% of the total weight of the liquid crystal composition: 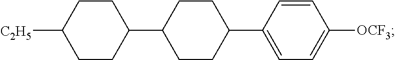 [SMILES: CCC1CCC(C2CCC(c3ccc(OC(F)(F)F)cc3)CC2)CC1]
a compound that accounts for 5% of the total weight of the liquid crystal composition: 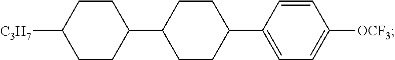
a compound that accounts for 30% of the total weight of the liquid crystal composition: 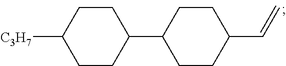
a compound that accounts for 10% of the total weight of the liquid crystal composition: 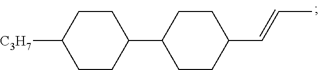
a compound that accounts for 3% of the total weight of the liquid crystal composition: 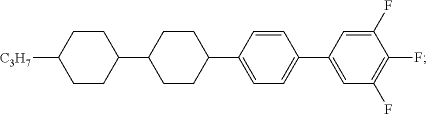
a compound that accounts for 4% of the total weight of the liquid crystal composition: 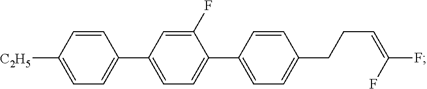 [SMILES: CCc1ccc(-c2ccc(-c3ccc(CCC=C(F)F)cc3)c(F)c2)cc1]
a compound that accounts for 5% of the total weight of the liquid crystal composition: 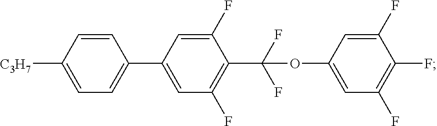
a compound that accounts for 10% of the total weight of the liquid crystal composition: 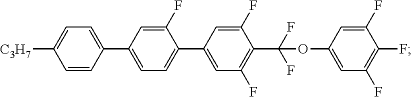
and
a compound that accounts for 7% of the total weight of the liquid crystal composition: [chemical structure]
